(19) United States
(12) Patent Application Publication
(10) Pub. No.: US 2024/0336842 A1
(43) Pub. Date: Oct. 10, 2024

(54) MICROWAVE-MEDIATED LIQUID CIRCULATION OF HYDROTHERMAL CARBONIZATION FOR HYDROCHAR PRODUCTION

(71) Applicant: The Florida State University Research Foundation, Inc., Tallahassee, FL (US)

(72) Inventor: Gang Chen, Tallahassee, FL (US)

(21) Appl. No.: 18/627,936

(22) Filed: Apr. 5, 2024

Related U.S. Application Data
(60) Provisional application No. 63/457,554, filed on Apr. 6, 2023.

(51) Int. Cl. C09K 17/42; C10L 9/08

(52) U.S. Cl. CPC C09K 17/42; C10L 9/086; C10L 2200/0469

(57) ABSTRACT

The present disclosure provides for a composition comprising a hydrochar, wherein the hydrochar comprises microwave-irradiated biomass. Further provided herein is a method of making the composition of claim 1, the method comprising: irradiating the biomass with microwaves under an inert atmosphere at conditions effective to yield the hydrochar. Also disclosed herein is a method of improving the quality of a soil comprising combining the soil with the composition disclosed herein.

### CROSS-REFERENCE TO RELATED APPLICATIONS

This application claims the benefit of priority to, and the benefit of, U.S. Provisional Application No. 63/457,554 filed on Apr. 6, 2023, the disclosure of which is hereby expressly incorporated by reference herein in its entirety.

### STATEMENT OF GOVERNMENT SUPPORT

This invention was made with government support under Grant Nos. 2016-67020-25275 and 2018-68002-27920, awarded by the National Institute of Food and Agriculture of Unites States Department of Agriculture. The government has certain rights in the invention.

### BACKGROUND

Hydrochar is the product of hydrothermal carbonization of raw biomass. Reactions such as hydrolysis, dehydration and decarboxylation initiate the charring process by breaking ester and ether bonds and removing H and O from the biomass in the form of H₂O and CO₂, eventually increasing the relative carbon content and heating value of produced hydrochar. The hydrolyzed organic molecules then undergo polymerization, recondensation, aromatization, Maillard reactions, etc. to increase high molecular weight species in the hydrochar. The resulting hydrochar is a solid residue that can complement coal for energy production. As an alternative for coal, hydrochar has been widely researched and preferred due to its high energy density, low fibrous structure, and high carbon content. There is a need for hydrochar with enhanced properties such as increased calorific value, heat capacity, lowered activation energy, improved carbon content compared to a hydrochar produced from a conventional hydrothermal carbonization process. The compositions and methods disclosed herein address these and other needs.

### SUMMARY

In accordance with the purposes of the disclosed materials and methods, as embodied and broadly described herein, the disclosed subject matter, in one aspect, relates to composition and method of making and using thereof.

Thus, in one example, a composition is provided, including hydrochar comprising microwave-irradiated biomass.

In a further example, a method of making the composition disclosed herein is provided, including irradiating the biomass with microwaves under an inert atmosphere at conditions effective to yield the hydrochar.

Additionally, a method of improving the quality of a soil is provided, including combining the soil with the composition disclosed herein.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF FIGURES

The accompanying figures, which are incorporated in and constitute a part of this specification, illustrate several aspects described below.

FIG. 1 shows the experimental setup of microwave-mediated liquid circulation of hydrothermal carbonization setup.

FIG. 2 shows the microwave hydrothermal synthesis setup.

FIG. 3 shows the effects of pH and ionic strength on the swelling capacity of hydrogel: a effect of pH by hydrogel type, b effect of ionic strength by hydrogel type, nonlinear regression analysis of relative swelling ratio change on c pH change, and d ionic strength change.

FIG. 4A-4E show optical microscope images (×150 magnification) showing the sequential formation of a tri-layered controlled-release fertilizer structure: a non-coated fertilizer granule, b poly(vinyl) alcohol (PVA)-coated fertilizer, c PVA-chitosan bi-layered fertilizer, d PVA/crosslinked-chitosan bi-layered fertilizer, and e PVA/crosslinked chitosan/poly(acrylic acid-co-acrylamide) tri-layered fertilizer. Reproduced from Noppakundilograt et al. (2015) with permission.

FIG. 5 shows the number of studies on hydrogel applications in agriculture every year from 2007 to 2022.

### DETAILED DESCRIPTION

The following description of the disclosure is provided as an enabling teaching of the disclosure in its best, currently known embodiments. Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As can be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It can be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of” Similarly, the term “consisting essentially of” is intended to include examples encompassed by the term “consisting of” As used in the specification and the appended claims, the singular forms “a,” “an” and “the” include plural referents unless the context clearly dictates otherwise. Thus, for example, reference to “a compound”, “a composition”, or “a disorder”, includes, but is not limited to, two or more such compounds, compositions, or disorders, and the like.

It should be noted that ratios, concentrations, amounts, and other numerical data can be expressed herein in a range format. It can be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it can be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise. As used herein, the term “substantially free,” when used in the context of a composition or component of a composition that is substantially absent, is intended to refer to an amount that is then about 1% by weight or less, e.g., less than about 0.5% by weight, less than about 0.1% by weight, less than about 0.05% by weight, or less than about 0.01% by weight of the stated material, based on the total weight of the composition.

### Composition

Disclosed herein is a composition comprising a hydrochar, wherein the hydrochar comprises microwave-irradiated biomass.

In some examples, the composition further comprises hydroxymethylfurfural (HMF).

In further examples, HMF is deposited on the hydrochar.

In certain examples, the composition further comprises an initiator.

In specific examples, the initiator comprises potassium persulfate, ammonium persulfate, or any combination thereof.

In some examples, the composition further comprises a crosslinker.

In further examples, the crosslinker comprises N,N-bisacrylamide methylene.

In certain examples, the composition further comprises a solvent.

In specific examples, the solvent comprises NaOH, urea, distilled H₂O, or any combination thereof.

In some examples, the composition further comprises biochar.

In further examples, the biochar is copolymerized with the hydrochar.

In certain examples, the biomass comprises switchgrass, water oak, leaves, biosolid, food waste, or any combination thereof.

In specific examples, the biomass is microwave-irradiated via microwave mediated hydrothermal carbonization.

In some examples, the composition has an increased heat capacity compared to a hydrochar produced from a conventional hydrothermal carbonization process.

In further examples, the composition has a reduced activation energy compared to a hydrochar produced from a conventional hydrothermal carbonization process.

In certain examples, the composition has a higher carbon content compared to a hydrochar produced from a conventional hydrothermal carbonization process.

Described are hydrochars including hydroxymethylfurfural (HMF). In some embodiments, the hydrochar can be a microwave mediated hydrothermal carbonization derived hydrochar. In some embodiments, the hydrochar can be generated using the method described herein.

In some embodiments, generation of the hydrochar can have an activation energy of at least 150 MJ/kg, (e.g., at least 160 MJ/kg, at least 170 MJ/kg, at least 180 MJ/kg, at least 190 MJ/kg, at least 200 MJ/kg, at least 210 MJ/kg, at least 220 MJ/kg, at least 230 MJ/kg, at least 240 MJ/kg, or at least 250 MJ/kg). In some embodiments, generation of the hydrochar can have an activation energy of 255 MJ/kg or less, (e.g., 250 MJ/kg or less, 245 MJ/kg or less, 240 MJ/kg or less, 235 MJ/kg or less, 230 MJ/kg or less, 225 MJ/kg or less, 220 MJ/kg or less, 215 MJ/kg or less, 210 MJ/kg or less, 205 MJ/kg or less, 200 MJ/kg or less, 195 MJ/kg or less, 190 MJ/kg or less, 185 MJ/kg or less, 180 MJ/kg or less, 175 MJ/kg or less, 170 MJ/kg or less, 165 MJ/kg or less, 160 MJ/kg or less, or 155 MJ/kg or less).

In some embodiments, generation of the hydrochar can have an activation energy ranging from any of the minimum values described above to any of the maximum values described above. For example, in some embodiments, generation of the hydrochar can have an activation energy of from 150 MJ/kg to 255 MJ/kg (e.g., 150 MJ/kg to 250 MJ/kg, 150 MJ/kg to 240 MJ/kg, 150 MJ/kg to 230 MJ/kg, 150 MJ/kg to 220 MJ/kg, 150 MJ/kg to 210 MJ/kg, 150 MJ/kg to 200 MJ/kg, 160 MJ/kg to 255 MJ/kg, 160 MJ/kg to 250 MJ/kg, 160 MJ/kg to 240 MJ/kg, 160 MJ/kg to 230 MJ/kg, 160 MJ/kg to 220 MJ/kg, 160 MJ/kg to 210 MJ/kg, 160 to 200 MJ/kg, 170 MJ/kg to 255 MJ/kg, 170 MJ/kg to 250 MJ/kg, 170 MJ/kg to 240 MJ/kg, 170 MJ/kg to 230 MJ/kg, 170 MJ/kg to 220 MJ/kg, 170 MJ/kg to 210 MJ/kg, 170 MJ/kg to 200 MJ/kg, 180 MJ/kg to 255 MJ/kg, 180 MJ/kg to 250 MJ/kg, 180 MJ/kg to 240 MJ/kg, 180 MJ/kg to 230 MJ/kg, 180 MJ/kg to 220 MJ/kg, 180 MJ/kg to 210 MJ/kg, or 180 MJ/kg to 200 MJ/kg). In some embodiments, generation of the hydrochar can have an activation energy of 190 MJ/kg.

In some embodiments, the hydrochar can have an increased heat capacity compared to a hydrochar produced from a conventional hydrothermal carbonization process. In some embodiments, the hydrochar can have a reduced activation energy compared to a hydrochar produced from a conventional hydrothermal carbonization process. In some embodiments, the hydrochar can have a higher carbon content compared to a hydrochar produced from a conventional hydrothermal carbonization process.

### Methods of Making

Also provided herein is a method of making the composition disclosed herein, the method comprising: irradiating the biomass with microwaves under an inert atmosphere at conditions effective to yield the hydrochar.

In some examples, the method further comprises recirculation of a liquid during the irradiation step.

In further examples, the conditions effective comprise irradiating with microwaves having a frequency, an energy, or a combination thereof, sufficient to heat the biomass to a temperature sufficient to yield the hydrochar.

In certain examples, the method is performed at a temperature of from 150° C. to 250° C. at a pressure of 6 MPa.

In specific examples, the irradiation step lasts from 5 minutes to 2 hours.

In some examples, generating the composition has an activation energy of from 150 MJ/kg to 255 MJ/kg.

Described herein also are methods of making a hydrochar including irradiating a feedstock material with microwaves under an inert atmosphere at conditions effective to yield a hydrochar. In some embodiments, the method can include recirculation of a liquid during the irradiation step. In some embodiments, the feedstock material can include food waste.

In some embodiments, the conditions effective to yield a hydrochar can include irradiating the feedstock material with microwaves having a frequency sufficient to heat the feedstock material to a temperature sufficient to yield the hydrochar. In some embodiments, the conditions effective to yield a hydrochar can include irradiating the feedstock material with microwaves having an energy sufficient to heat the feedstock material to a temperature sufficient to yield the hydrochar. In some embodiments, the effective conditions can include elevated pressure when irradiating the feedstock material with microwaves to heat the feedstock material to a temperature sufficient to yield the hydrochar.

In some embodiments, the microwaves can have a frequency of from 0.3 GHz to 50 GHz, (e.g., 0.3 GHz to 25 GHz, 0.3 GHz to 10 GHz, 0.3 GHz to 5 GHz, 5 GHz to 50 GHz, 5 GHz to 25 GHz, 5 GHz to 10 GHz, 10 GHz to 50 GHz, 10 GHz to 25 GHz, 20 GHz to 50 GHz, or 20 GHz to 25 GHz). In some embodiments, the microwaves have a frequency of 2.45 GHz.

In some embodiments, the microwaves can be generated by magnetrons having an operating power of from 300 watts to 2000 watts (e.g., from 500 watts to 2000 watts, from 750 watts to 2000 watts, from 1000 watts to 2000 watts, from 1500 watts to 2000 watts, from 300 watts to 1500 watts, from 500 watts to 1500 watts, from 750 watts to 1500 watts, from 1000 watts to 1500 watts, from 300 watts to 1000 watts, from 500 watts to 1000 watts, from 750 watts to 1000 watts, from 300 watts to 750 watts, from 500 watts to 750 watts, or from 300 watts to 500 watts). In some embodiments, the microwaves are generated by magnetrons having an operating power of 1600 watts.

In some embodiments, the temperature can be at least 100° C. at a pressure of 6 MPa, (e.g., at least 100° C., at least 110° C., at least 120° C., at least 130° C., at least 140° C., at least 150° C., at least 160° C., at least 170° C., at least 180° C., at least 190° C., at least 200° C., at least 210° C., at least 220° C., at least 230° C., or at least 240° C.). In some embodiments, the temperature can be 300° C. or less at a pressure of 6 MPa, (e.g., 300° C. or less, 290° C. or less, 280° C. or less, 270° C. or less, 260° C. or less, 250° C. or less, 240° C. or less, 230° C. or less, 220° C. or less, 210° C. or less, 200° C. or less, 190° C. or less, 180° C. or less, 170° C. or less, 160° C. or less, or 150° C. or less).

In some embodiments, the temperature can range from any of the minimum values described above to any of the maximum values described above. For example, in some embodiments, the temperature can range from 100° C. to 300° C. (e.g., from 100° C. to 290° C., from 100° C. to 280° C., from 100° C. to 270° C., from 100° C. to 260° C., from 100° C. to 250° C., from 100° C. to 240° C., from 100° C. to 230° C., from 100° C. to 220° C., from 100° C. to 210° C., from 110° C. to 300° C., from 110° C. to 290° C., from 110° C. to 280° C., from 110° C. to 270° C., from 110° C. to 260° C., from 110° C. to 250° C., from 110° C. to 240° C., from 110° C. to 230° C., from 110° C. to 220° C., from 110° C. to 210° C., from 120° C. to 300° C., from 120° C. to 290° C., from 120° C. to 280° C., from 120° C. to 270° C., from 120° C. to 260° C., from 120° C. to 250° C., from 120° C. to 240° C., from 120° C. to 230° C., from 120° C. to 220° C., from 120° C. to 210° C., from 130° C. to 300° C., from 130° C. to 290° C., from 130° C. to 280° C., from 130° C. to 270° C., from 130° C. to 260° C., from 130° C. to 250° C., from 130° C. to 240° C., from 130° C. to 230° C., from 130° C. to 220° C., from 130° C. to 210° C., from 140° C. to 300° C., from 140° C. to 290° C., from 140° C. to 280° C., from 140° C. to 270° C., from 140° C. to 260° C., from 140° C. to 250° C., from 140° C. to 240° C., from 140° C. to 230° C., from 140° C. to 220° C., from 140° C. to 210° C., from 150° C. to 300° C., from 150° C. to 290° C., from 150° C. to 280° C., from 150° C. to 270° C., from 150° C. to 260° C., from 150° C. to 250° C., from 150° C. to 240° C., from 150° C. to 230° C., from 150° C. to 225° C., from 150° C. to 220° C., from 150° C. to 210° C., from 160° C. to 300° C., from 160° C. to 290° C., from 160° C. to 280° C., from 160° C. to 270° C., from 160° C. to 260° C., from 160° C. to 250° C., from 160° C. to 240° C., from 160° C. to 230° C., from 160° C. to 225° C., from 160° C. to 220° C., from 160° C. to 210° C., from 170° C. to 300° C., from 170° C. to 290° C., from 170° C. to 280° C., from 170° C. to 270° C., from 170° C. to 260° C., from 170° C. to 250° C., from 170° C. to 240° C., from 170° C. to 230° C., from 170° C. to 225° C., from 170° C. to 220° C., from 170° C. to 210° C., from 175° C. to 250° C., from 175° C. to 240° C., from 175° C. to 230° C., from 175° C. to 225° C., from 175° C. to 220° C., from 175° C. to 210° C., from 180° C. to 300° C., from 180° C. to 290° C., from 180° C. to 280° C., from 180° C. to 270° C., from 180° C. to 260° C., from 180° C. to 250° C., from 180° C. to 240° C., from 180° C. to 230° C., from 180° C. to 225° C., from 180° C. to 220° C., from 180° C. to 210° C., from 190° C. to 300° C., from 190° C. to 290° C., from 190° C. to 280° C., from 190° C. to 270° C., from 190° C. to 260° C., from 190° C. to 250° C., from 190° C. to 240° C., from 190° C. to 230° C., from 190° C. to 225° C., from 190° C. to 220° C., or from 190° C. to 210° C.) at a pressure of 6 MPa.

In some embodiments, the irradiation step can last at least 2 minutes, (e.g., at least 2 minutes, at least 3 minutes, at least 4 minutes, at least 5 minutes, at least 10 minutes, at least 15 minutes, at least 20 minutes, at least 25 minutes, at least 30 minutes, at least 35 minutes, at least 40 minutes, at least 45 minutes, at least 50 minutes, at least 1 hour, at least 1.25 hours, at least 1.5 hours, or at least 1.75 hours). In some embodiments, the irradiation step can last 2.5 hours or less, (e.g., 2.5 hours or less, 2.25 hours or less, 2 hours or less, 1.75 hours or less, 1.5 hours or less, 1.25 hours or less, 1.5 hours or less, 55 minutes or less, 50 minutes or less, 45 minutes or less, 40 minutes or less, 35 minutes or less, 30 minutes or less, 25 minutes or less, 20 minutes or less, 15 minutes or less, 10 minutes or less, or 5 minutes or less).

In some embodiments, the irradiation can last from any of the minimum values described above to any of the maximum values described above. For example, in some embodiments, the irradiation step can last from 2 minutes to 2.5 hours (e.g., from 2 minutes to 2.25 hours, from 2 minutes to 2 hours, from 2 minutes to 1.75 hours, from 2 minutes to 1.5 hours, from 2 minutes to 1.25 hours, from 2 minutes to 1 hour, from 2 minutes to 55 minutes, from 2 minutes to 50 minutes, from 2 minutes to 45 minutes, from 3 minutes to 2.5 hours, from 3 minutes to 2.25 hours, from 3 minutes to 2 hours, from 3 minutes to 1.75 hours, from 3 minutes to 1.5 hours, from 3 minutes to 1.25 hours, from 3 minutes to 1 hour, from 3 minutes to 55 minutes, from 3 minutes to 50 minutes, from 3 minutes to 45 minutes, from 4 minutes to 2.5 hours, from 4 minutes to 2.25 hours, from 4 minutes to 2 hours, from 4 minutes to 1.75 hours, from 4 minutes to 1.5 hours, from 4 minutes to 1.25 hours, from 4 minutes to 1 hour, from 4 minutes to 55 minutes, from 4 minutes to 50 minutes, from 4 minutes to 45 minutes, from 5 minutes to 2.5 hours, from 5 minutes to 2.25 hours, from 5 minutes to 2 hours, from 5 minutes to 1.75 hours, from 5 minutes to 1.5 hours, from 5 minutes to 1.25 hours, from 5 minutes to 1 hour, from 5 minutes to 55 minutes, from 5 minutes to 50 minutes, from 5 minutes to 45 minutes, from 10 minutes to 2.5 hours, from 10 minutes to 2.25 hours, from 10 minutes to 2 hours, from 10 minutes to 1.75 hours, from 10 minutes to 1.5 hours, from 10 minutes to 1.25 hours, from 10 minutes to 1 hour, from 10 minutes to 55 minutes, from 10 minutes to 50 minutes, from 10 minutes to 45 minutes, from 15 minutes to 2.5 hours, from 15 minutes to 2.25 hours, from 15 minutes to 2 hours, from 15 minutes to 1.75 hours, from 15 minutes to 1.5 hours, from 15 minutes to 1.25 hours, from 15 minutes to 1 hour, from 15 minutes to 55 minutes, from 15 minutes to 50 minutes, or from 15 minutes to 45 minutes).

In some embodiments, the irradiating step can last from 1 minute to 120 minutes with microwaves having a frequency of 2.45 GHz generated by magnetrons having an operating power of 1600 watts.

In some embodiments, the hydrochar can have an increased heat capacity compared to a hydrochar produced from conventional hydrothermal carbonization processes. In some embodiments, the hydrochar can have a higher carbon content compared to a hydrochar produced from conventional hydrothermal carbonization processes. In some embodiments, the hydrochar can have an increased calorific value compared to a hydrochar produced from conventional hydrothermal carbonization processes. In some embodiments, the hydrochar can have a reduced activation energy compared to a hydrochar produced from conventional hydrothermal carbonization processes.

In some embodiments, generation of the hydrochar can have an activation energy of at least 150 MJ/kg, (e.g., at least 160 MJ/kg, at least 170 MJ/kg, at least 180 MJ/kg, at least 190 MJ/kg, at least 200 MJ/kg, at least 210 MJ/kg, at least 220 MJ/kg, at least 230 MJ/kg, at least 240 MJ/kg, or at least 250 MJ/kg). In some embodiments, generation of the hydrochar can have an activation energy of 255 MJ/kg or less, (e.g, 250 MJ/kg or less, 245 MJ/kg or less, 240 MJ/kg or less, 235 MJ/kg or less, 230 MJ/kg or less, 225 MJ/kg or less, 220 MJ/kg or less, 215 MJ/kg or less, 210 MJ/kg or less, 205 MJ/kg or less, 200 MJ/kg or less, 195 MJ/kg or less, 190 MJ/kg or less, 185 MJ/kg or less, 180 MJ/kg or less, 175 MJ/kg or less, 170 MJ/kg or less, 165 MJ/kg or less, 160 MJ/kg or less, or 155 MJ/kg or less).

In some embodiments, generation of the hydrochar can have an activation energy ranging from any of the minimum values described above to any of the maximum values described above. For example, in some embodiments, generation of the hydrochar can have an activation energy of from 150 MJ/kg to 255 MJ/kg (e.g., 150 MJ/kg to 250 MJ/kg, 150 MJ/kg to 240 MJ/kg, 150 MJ/kg to 230 MJ/kg, 150 MJ/kg to 220 MJ/kg, 150 MJ/kg to 210 MJ/kg, 150 MJ/kg to 200 MJ/kg, 160 MJ/kg to 255 MJ/kg, 160 MJ/kg to 250 MJ/kg, 160 MJ/kg to 240 MJ/kg, 160 MJ/kg to 230 MJ/kg, 160 MJ/kg to 220 MJ/kg, 160 MJ/kg to 210 MJ/kg, 160 to 200 MJ/kg, 170 MJ/kg to 255 MJ/kg, 170 MJ/kg to 250 MJ/kg, 170 MJ/kg to 240 MJ/kg, 170 MJ/kg to 230 MJ/kg, 170 MJ/kg to 220 MJ/kg, 170 MJ/kg to 210 MJ/kg, 170 MJ/kg to 200 MJ/kg, 180 MJ/kg to 255 MJ/kg, 180 MJ/kg to 250 MJ/kg, 180 MJ/kg to 240 MJ/kg, 180 MJ/kg to 230 MJ/kg, 180 MJ/kg to 220 MJ/kg, 180 MJ/kg to 210 MJ/kg, or 180 MJ/kg to 200 MJ/kg).

Described herein are also methods of using the hydrochar described herein as a solid fuel.

Further provided herein is a method of improving the quality of a soil comprising combining the soil with the composition disclosed herein.

Reference will now be made in detail to specific aspects of the disclosed materials, compounds, compositions, articles, and methods, examples of which are illustrated in the accompanying Examples and Figures.

A number of embodiments of the disclosure have been described. Nevertheless, it will be understood that various modifications may be made without departing from the spirit and scope of the invention. Accordingly, other embodiments are within the scope of the following claims.

By way of non-limiting illustration, examples of certain embodiments of the present disclosure are given below.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations are accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures, and other reaction ranges and conditions that can be used to optimize the product purity and yield obtained from the described process.

### Example 1: Microwave-Mediated Liquid Circulation of Hydrothermal Carbonization for Hydrochar Production

Microwave-mediated hydrothermal carbonization (MWHTC) is a low-temperature thermochemical conversion process, which can convert wet biomass such as food waste to hydrochar without high energy-consuming pre-drying. MWHTC involves microwave dielectric heating, created by the flipping of the orientation of the electric dipoles in the food waste. MWHTC is thus attractive for the heating efficiency with advantages over conventional pyrolysis as it does not require drying, and heat transfer directly occurs within the waste by convection and not by conduction. MWHTC can also overcome the obstacle of process water remediation by introducing the process water, which contains high organic contents, to the MWHTC process when converting wet waste to conversion-ready feedstocks. During MWHTC, water acts as a medium of heat transfer, and microwave irradiation provides rapid dipole rotation and generates inherent heat within the waste, which significantly speed up the reaction process. MWHTC takes the advantage of the moisture content in the waste, which also reduces the activation energy of the hydrolytic breakdown of the food waste, resulting in less energy required for the process to take place.

In recent years, MWHTC technology has received growing attention at various scales with potential implementation with different biomass waste, such as sewage sludge, animal manure, biowaste, lignocellulosic biomass, and mixed residues. Because of the high moisture content of food waste, MWHTC has a high potential to be used to convert food waste to hydrochar. The ability of MWHTC to produce clean solid biofuel from wet biomass waste has a bright future. MWHTC is an effective method to produce hydrochar from food waste, which has advantageous characteristics such as rapid heating and selective heating.

The hydrothermal carbonization process offers numerous advantages that make it more suitable for treating food waste in comparison to other technologies, such as pyrolysis or gasification. While treating food waste by MWHTC, depolymerization, decomposition, and degradation of polymeric compounds from the food waste take place to generate hydrochar (Son Le et al., Bioresour Technol, 2022, 127958). With the process of MWHTC, the C/O ratio increases, which leads to an increase in the higher heating value of the end-product, i.e., hydrochar (Sharma et al., Sci Total Environ, 2022, 806, 150748). When used as a solid fuel, hydrochar can satisfy several requirements such as combustion behavior, hydrophobicity, energy density, thermal stability, grindability, etc. (Zhang et al., Water Res, 2021, 198, 117170). Compared to other thermochemical conversion methods, MWHTC takes advantage of the moisture content in the waste, which also reduces the activation energy of the hydrolytic breakdown of the biomass, resulting in less energy requirements. Depending upon the raw waste, hydrochar has a calorific value in the range of 6,450-12,900 BTU/lb. (15-30 MJ/kg), a sufficient energy content to be used as solid fuel (Xu et al., Sci Total Environ, 2022, 850, 157953). In addition, hydrochar can be utilized as feedstocks for synthesis of liquid fuels (bio-oil and blend-stock fuel) and gaseous fuels (syngas).

Food waste has inherent heterogeneously variable compositions, high moisture contents and low calorific value, which constitute an impediment for the development of efficient energy recovery processes. A considerable amount of research has been conducted to convert food waste to renewable energy using technologies for food waste-to-energy conversion, including biological (e.g., anaerobic digestion and fermentation), thermal and thermochemical means (e.g., incineration, pyrolysis, gasification, and hydrothermal oxidation) (De Clercq et al., Sci Total Environ, 2019, 673, 402; Jones-Garcia et al., Foods, 2022, 11, 2018; Vinardell et al., Bioresour Technol, 2021, 330, 124978; Yin et al., Environ Technol, 2017, 38, 1735; Zhang et al., Front Nutr, 2022, 9, 986705). The competitive advantages of MWHITC as compared with these technologies as well as the challenges associated with these technologies are summarized in Table 1.

TABLE 1
Comparison of Energy Recovery Technologies for Food Waste

| | Energy | Activation | Pre-Drying | Process | Facility |
|---|---|---|---|---|---|
| Technologies | Recovery | Energy | Requirements | Wastewater | Investment |
| Landfill Gas | Low | Low | No | Yes | Yes |
| Recovery | | | | | |
| Anaerobic | Medium | Medium | No | Yes | Yes |
| Digestion | | | | | |
| Combustion | High | High | Yes | No | Yes |
| Gasification | High | High | Yes | No | Yes |
| Pyrolysis | High | High | Yes | No | Yes |
| Conventional | High | Medium | No | Yes | Yes |
| Hydrothermal | | | | | |
| Carbonization | | | | | |
| MWHTC | High | Low | No | No | Yes |

The methods also include liquid recirculation to enhance reactions of hydrolysis, dehydration, decarboxylation, polymerization, recondensation, aromatization, Maillards reactions, etc. (Bhakta Sharma et al., Bioresour Technol, 2021, 333, 125187; Khan et al., Polymers, 2022, 14, 821) Reactions such as hydrolysis, dehydration and decarboxylation initiate the charring process by breaking ester and ether bonds and removing H and 0 from the biomass in the form of H₂O and CO₂, eventually increasing the relative carbon content and heating value of hydrochar. The hydrolyzed organic molecules then undergo polymerization, recondensation, aromatization, Maillard reactions, etc. to increase high molecular weight species in the hydrochar. MWHTC produces relatively small amounts of gases including CO₂, CO, CH₄, and H₂ as well as bio-oil species, which can be collected and reused. The methods deposit hydroxymethylfurfural (HMF), an organic compound formed by the dehydration of food waste with high heating values to the produced hydrochar, which further increases the hydrochar porosity and augment the overall energy density of hydrochar.

The rapid dipole rotation by microwave irradiation introduces energy to the food waste more efficiently, which significantly speeds up hydrothermal carbonization (Nizamuddin et al., Materials, 2019, 12, 403; Zhang et al., Chemosphere, 2022, 291, 132787). Compared to conventional thermal heating, microwave irradiation is performed at deliberately chosen temperatures to shift the reaction equilibrium and kinetics since the absorption of radiation is temperature independent (Wang et al., Sci Total Environ, 2022, 803, 149874). Internal energy and Gibbs free energy of the food waste undergo significant changes in the microwave field in a short period of time, which can achieve stable thermodynamic properties of conversion-ready hydrochar.

The liquid circulation in the high-energy-radiation field of microwave provides unique features of solid-state polymerization, recondensation, aromatization, Maillard reactions, etc. to stabilize and improve the produced hydrochar. MWHTC is simple to operate with limited additives. It is also space-saving and can largely reduce the processing costs.

### Materials and Methods

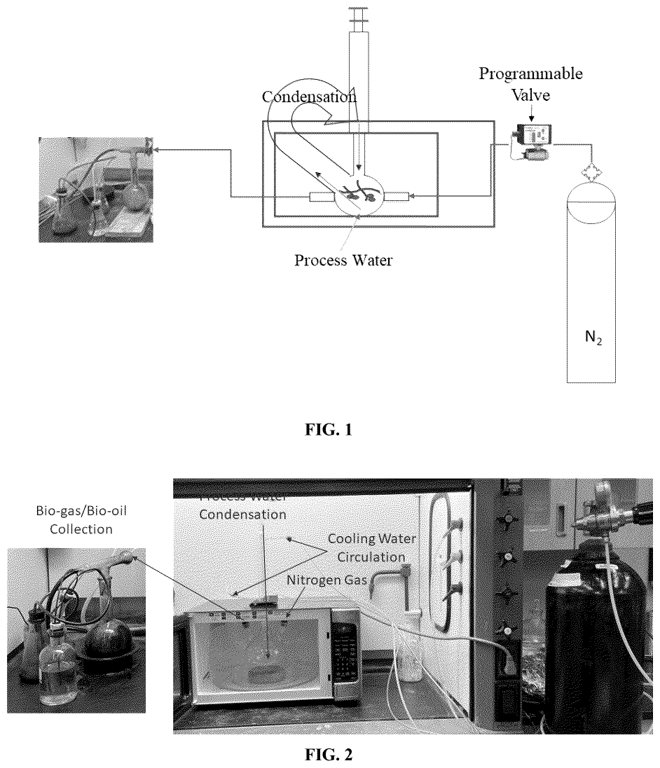

Liquid circulated MWHTC can be carried out using a custom-made microwave hydrothermal synthesis instrument with a 2.45 GHz, 1600 W microwave oven at temperatures ranging from 150° C. to 250° C. at 6 MPa for 5 to 120 min with process water circulated to the reaction, which can be achieved by vapor water condensation outside the microwave oven and recirculation back to the reactor (FIG. 1). The food waste is chopped to small pieces and be heated up to the set reaction temperatures (i.e., 150, 175, 200, 225, and 250° C.) and maintained for the reaction time (i.e., 5, 10, 25, 50, 75, 100, and 120 min).

As the MWHTC process occurs at a lower temperature, the carbon conversion is lower than in pyrolysis, resulting in higher atomic H/C and O/C ratios (Chen et al., ACS Omega, 2021, 6, 16546). Thus, hydrochar has higher atomic ratios of hydrogen to carbon and oxygen to carbon, compared to those of biochar. Hydrochar is also slightly acidic compared to biochar as hydrochar contains more oxygenated functional groups (Sharma et al., Waste Manag, 2019, 91, 108). During MWHTC, some of the inorganics are washed away by the process water, resulting in acidic pH for hydrochar. Hydrochar yields by MWHTC is calculated by (Kang et al., Glob Change Biol Bioenergy, 2021, 13, 1690):

$$Hydrochar yield ( \% ) = Weight of hydrochar / Weight of dry food waste$$

The heating value (HHV) of the hydrochar is calculated according to:

$$H H V ( kJ / kg ) = 337 C + 1419 ( H - 0.125 O ) + 23.26 N$$

where C, H, O, and N represent the weight percentage of each element in the waste. Energy densification indicates the energy retention in hydrochar, which is defined as (Wang et al., Sci Total Environ, 2022, 803, 149874):

$$Energy densification = H H V of hydrochar / H H V of food waste$$

The energy required for running the MWHTC process is calculated as (Wang et al., Sci Total Environ, 2022, 803, 149874):

$${Q}_{req} = ρ {V}_{s} C ( {T}_{p} - {T}_{e} )$$

where ρ is the density of the waste, Vₛ is the volume of the waste, C is the specific heat capacity, Tₚ is the MWHTC temperature, and Tₑ is the environmental temperature.

Thermogravimetric analysis (TGA) can be conducted to determine the combustion characteristics of the produced hydrochar. The TGA weight loss profile of the hydrochar can be fitted with the following combustion reaction rate equation (Ro et al., ACS Sustain Chem Eng, 2019, 7, 470):

$$\frac{d α}{{( 1 - α )}^{n}} = \frac{A}{β} exp ( - \frac{E}{RT} ) dT$$

where A is the pre-exponential factor, E is the activation energy, R is the universal gas constant, T is absolute temperature n is the order of the reaction, and α is the fraction of conversion, i.e.,

$$α = \frac{{m}_{0} - {m}_{T}}{{m}_{0} - {m}_{f}}$$

with mo representing the initial dry mass, m_{T} representing the mass at temperature T, mf representing the final residual mass that consists of mostly fixed carbon and ash, and β representing the constant heating rate.

Assuming a first-order thermal decomposition reaction for combustion (n=1), above equation is rearranged as:

$$Ln ( \frac{d α}{dT} {( 1 - α )}^{- 1} ) = Ln ( \frac{A}{β} ) - \frac{E}{RT}$$

The values of dα/dT and α can be obtained from the TGA analysis.

$$Ln ( \frac{d α}{dT} {( 1 - α )}^{- 1} )$$

can be plotted against the inverse of the absolute temperature, T and a linear model can be fitted to each combustion stage with an intercept of (A/β) and a slope of −E/R.

The surface morphology of the hydrochar can be obtained on a scanning electron microscope (SEM, Hitachi SU8010, Japan) operated at 200 kV. The specific surface area can be measured on a Micrometrics ASAP 2020 analyzer and calculated according to the Brunauer-Emmett-Teller (BET) method. The chemical functional groups of the hydrochar can be determined using a Fourier transform infrared (FTIR) spectrometer (Nicolet 5700, USA).

### Results

Typical hydrothermal carbonization produces approximately 7% gases, 65% process water, and 15% solids, with an additional 13% water evaporated during drying of the post-hydrothermal carbonization to obtain the hydrochar. The overall actual yields of hydrochar are 39.5 wt % (Gupta et al., Bioresour Technol, 2021, 342, 125972). MWHTC is superior to conventional hydrothermal carbonization with higher hydrochar yields (45.1 vs. 39.5 wt %) and significantly reduced energy consumption (0.63 vs. 2.74 MJ/g). In addition, hydrochar production by MWHTC has a lower activation energy of ˜190 MJ/kg than that of conventional hydrothermal carbonization processes (˜260 MJ/kg) (Zhang et al., Chemosphere, 2022, 291, 132787).

Microwave-based liquid-recirculation further increases the hydrochar yields and improves the heating value of the produced hydrochar. Recirculating the process water also eliminates the need for fresh water and subsequent remediation requirements (Sharma et al., Sci Total Environ, 2022, 806, 150748). Microwave energy comprises electromagnetic spectrum, which triggers molecular motion by ion movement and dipole rotation without affecting the molecular structure. Polar substances such as water help food waste be heated. Specifically, water comprises of a negatively charged oxygen atom and two positively charged hydrogen atoms. The negatively charged end of the microwave attracts the positively charged end of water and vice versa. Thus, as microwaves oscillate, water molecules rotate, resulting in intermolecular collisions to generate heat, which is transferred by convection, conduction, or radiation. Water has high dielectric properties. Therefore, it is able to assist in the penetration of microwave energy.

Overall, this design has a short process time with 5-10 times decrement in reaction time since the microwave heats the target food waste by applying the electromagnetic field, while conventional heating applies the interfacial heat transfer. In MWHTC, microwave radiation penetrates the food waste and converts microwave energy into internal energy with heat transferred inside-out (Knappe et al., J Vis Exp, 2019, e58970, doi:10.3791/58970).

The hydrochar produced through the methods described herein is a carbon-neutral solid biofuel, which is the future energy source because the low sulfur and nitrogen contents in solid biofuel are a huge advantage to reduce pollution. Compared to conventional hydrothermal carbonization, MWHTC with liquid recirculation improves the yields, reduces heat losses, and decreases residence time. The molecular heating level is increased in the microwave heating, leading to homogeneous temperature elevation. Cost and energy-efficient are notable advantages of MWHTC. In addition, it is more controllable, with a high processing rate and low residence time, while consuming lower energy. The long-range impacts of MWHTC thus include increased calorific value (CV) or heating value of conversion-ready feedstocks (i.e., hydrochar), low energy input (i.e., no pre-drying requirements), and decreased environmental contamination (i.e., no treatment requirement of process water).

### Example 2: Hydrogels as Water and Nutrient Reservoirs in Agricultural Soil: A Comprehensive Review of Classification, Performance, and Economic Advantages

### Introduction

The exponential growth of the global population poses significant challenges to sustainable development (Liu et al., 2018a, 2018b). Projections indicate that the world's population will reach 9.8 billion by 2050 (Kotkin, 2010). Meeting the food demands of this substantial population necessitates a minimum 70% improvement in agricultural production (Kotkin, 2010). However, the ability of agricultural soils to retain water and nutrients has been severely compromised due to factors such as reduced precipitation, rising temperatures, and increased occurrences of extreme weather events at regional and global scales (Saha et al., 2020). This degradation is particularly pronounced in arid and semiarid regions where evaporation and evapotranspiration rates are more pronounced (Ji et al., 2022).

The inefficient utilization of water and nutrients by crops not only leads to economic losses but also has detrimental effects on the environment (Li et al., 2018; Salim & Raza, 2020). Excessive nutrient input can eventually leach into groundwater or be carried away by surface runoff, resulting in water pollution issues such as eutrophication (Wu et al., 2020) and other ecological problems (Moal et al., 2019). Recognizing the escalating demand for irrigation water and fertilizers to ensure agricultural productivity, the urgent need to enhance water and nutrient use efficiency has gained global attention in recent years (Li & Chen, 2019, 2020b).

Hydrogels, commonly referred to as water-swollen superabsorbent polymers (SAPs), have been extensively studied and historically utilized as soil amendments (Li & Chen, 2019, 2020b). Their unique permeable structures and diverse hydrophilic functional groups make them promising reservoirs for excess water and nutrients in agricultural soils (Hüttermann et al., 2009). These hydrogels possess the ability to efficiently absorb and temporarily retain large amounts of liquid within their three-dimensional polymeric networks (Li & Chen, 2018b). Previous review reported that conventional polyacrylamide hydrogels could retain distilled water up to 326 times their dry weight (Kim et al., 2010). In recent decades, the properties and applications of hydrogels have significantly expanded beyond their conventional use as water absorbents. They now encompass complex polymeric architectures designed for absorbing specific chemicals such as heavy metals (Li & Chen, 2018b; Yi et al., 2018), dyes (Qi et al., 2018), phosphates (Singh & Singhal, 2018), and ammonium (Cruz et al., 2018). Moreover, when hydrogels are applied and hydrated in agricultural soils, they effectively enhance soil porosity and improve oxygen availability (Guilherme et al., 2015). This enhanced soil aeration is conducive to plant growth, facilitating the decomposition of organic matter (Ben-Noah & Friedman, 2016). Research has provided evidence to support the benefits of utilizing hydrogels in agriculture, including reduced irrigation frequency, mitigation of soil compaction, erosion control, and decreased water runoff (Abobatta, 2018; Narjary et al., 2013). When properly designed and applied at appropriate rates, hydrogels can function as a controlled release system, facilitating the absorption of excess water in the soil without causing ponding during storm events. A recent study has provided compelling evidence that the application of hydrogels at a concentration of 5% (w/w) can significantly enhance the field capacity of the soil by 55% and reduce runoff by 28% (Garduque et al., 2020). These findings clearly demonstrate the positive influence of hydrogel applications on local hydrology.

The hydrogels currently employed or tested in agriculture are predominantly artificially synthesized (Li & Chen, 2019; Wu et al., 2021b). While many of these commercial hydrogel products are inexpensive (e.g., less than 1 USD per kg) and exhibit effectiveness (Li & Chen, 2018b), their long-term use may give rise to concerns. Conventional hydrogels often pose challenges in terms of decomposition within soils or can degrade into smaller molecules that are toxic to soil biota, potentially leading to adverse effects on human health through the food chain. Consequently, the sustained use of conventional hydrogels could hinder agricultural production. For instance, the intermediate degradation products of acrylate-based hydrogels have been found to be cytotoxic (i.e., toxic to living cells) (Puoci et al., 2008). To circumvent such undesirable consequences associated with conventional (yet unsustainable) hydrogels, there has been considerable research attention focused on biodegradable and biocompatible hydrogels in recent years (Akalin & Pulat, 2018; Wu et al., 2021a). Many of these innovative hydrogels are derived from polysaccharides, such as cellulose, lignin, and chitosan, which are abundant natural polymers on Earth. However, the wide-scale application of polysaccharide-based hydrogels is hindered by their high production costs and complex purification processes (Guilherme et al., 2015).

### Material Resources of Hydrogels in Agricultural Application

The synthesis of hydrogels typically involves the use of initiators, crosslinkers, monomers, and occasionally special solvents, following specific polymerization techniques (Li & Chen, 2020a). Different polymerization methods, such as bulk (or mass), solution, or suspension polymerization, are commonly employed to produce hydrogels with distinct properties tailored for specific applications (Ahmed, 2015). Hydrogels can be classified in various ways, including based on their source, polymeric composition, configuration, type of crosslinking, physical appearance, or network electrical charge. For example, based on the origin of the monomers and the biocompatibility of the final product, hydrogels can be categorized as traditional synthetic hydrogels, biodegradable synthetic hydrogels, or hybrid hydrogels, as illustrated in Table 1. Another classification criterion is the polymerization or crosslinking method, which divides hydrogels into chemically modified hydrogels (e.g., through radical, ion, or step polymerization) and physically modified hydrogels (e.g., via radiation or emulsion methods) (Hennink & van Nostrum, 2012). Furthermore, hydrogels can be grouped based on the presence or absence of electrical charge on the crosslinked chains. They are classified into four categories: nonionic (neutral), ionic (either anionic or cationic), ampholytic (containing both acidic and basic groups), and zwitterionic (with both anionic and cationic groups in each structural repeating unit) (Ahmed, 2015). It is worth noting that hydrogels suitable for agricultural applications may belong to any of the aforementioned types.

TABLE 1
Hydrogels commonly applied in agriculture and their chemical compositions.

| Hydrogel | | | | | Application(s) | |
|---|---|---|---|---|---|---|
| Type | Composition Monomer(s) | Initiator | Crosslinker(s) | Other | in Agriculture | References |
| Traditional | AA¹ + AAm² + AN³ + | APS⁴ | MBA¹⁷ | | Superabsorbent | Raju an Raju (2001b) |
| synthetic | MAA¹⁶ + HEMA¹⁰ | | | | | |
| hydrogels | | | | | | |
| | AAm + NaAA¹⁹ + KA¹³ | APS | MBA | | Superabsorbent | Raju and Raju (2001a) |
| | AAm + HEMA + KMA¹⁴ | APS | MBA + EGDMA⁹ + | | Superabsorbent | Raju et al., (2002) |
| | | | dial-lyl phthalate | | | |
| | AA | APS | MBA | Kaolin | Superabsorbent | Kabiri and Zohuriaan- |
| Biodegradable | Starch + PVA²⁵ | — | Maleic acid | | Superabsorbent | Pang et al. (2011) |
| synthetic | | | | | | |
| hydrogels | | | | | | |
| | Xanthan + PVA | — | Epichlorohydrin | | Superabsorbent | Alupei et al. (2002) |
| | Cassava starch + | APS | MBA | — | Superabsorbent | Tanan et al. (2019) |
| | Natural rubber + | | | | | |
| | PVA + AA | | | | | |
| | Cassava starch + | APS | MBA | Urea | SRF (Urea) | Tanan et al. (2021) |
| | Natural rubber + | | | | | |
| | PVA + AA | | | | | |
| Hybrid | Collagen + AA + AAm | KPS | MBA | Clay | Superabsorbent | Marandi et al. (2011) |
| hydrogels | | | | | | |
| | NaCMC²⁰ + HEC¹¹ | — | Citric acid | | Superabsorbent | Montesano et al. (2015) |
| | NaCMC + AA + PVP²⁶ | APS⁴ | MBA | Silica | SRF²⁷ (N, P²⁴ and K¹²) | Ali Olad et al., |
| | | | | | | (2018a, |
| | Cornstarch + glucose + AAm | CAN | MBA | | SRF (Urea) | Xiao et al. (2017) |
| | Pectin + Aam + NaAA¹⁹ | NaPS²¹ | EDGMA | | SRF (N, P and K) & | Guilherme et al. (2010) |
| | | | | | Remediation | |
| | Chitosan | — | Glutaraldehyde | | Remediation | Juarez-Maldonado et |
| | | | | | | al. (2016) |
| | CFP⁶ + AA + PVA | KPS + NC + | MBA | | SRF (N, P and K) | Kong et al. (2019) |
| | | NaSITA²² | | | | |
| | Rice husk + gelatin + | KPS¹⁵ | MBA | | Superabsorbent | Kenawy et al. (2021 |
| | Aam + AA | | | | | |
| | Cornstarch + AA + | APS | MBA | Urea | Superabsorbent | Bora and Karak (2022) |
| | Itaconic acid | | | | and SRF (Urea) | |
| | Gum tragacanth + | Lipase | Glutaraldehyde | Urea | Superabsorbent | Saruchi et al. (2019) |
| | Aam + MAA | | | | and SRF (Urea) | |

AA¹, acrylic acid;
AAm², acrylamide;
AN³, acrylonitrile;
APS⁴, ammonium persulfate;
CAN⁵, ceric ammonium nitrate;
CFP⁶, chicken feather protein;
CMC⁷, carboxymethyl cellulose (cellulose gum);
CRF⁸, controlled release fertilizer;
EGDMA⁹, ethylene glycol dimethacrylate;
HEMA¹⁰, 2-hydroxyethyl methacrylate;
HEC¹¹, hydroxyethyl cellulose;
K¹², potassium;
KA¹³, potassium acrylate;
KMA¹⁴, potassium methacrylate;
KPS¹⁵, potassium persulfate;
MAA¹⁶, methacrylic acid;
MBA¹⁷, N,N′-methylenebisacrylamide;
N¹⁸, nitrogen;
NaAA¹⁹, sodium acrylate;
NaCMC²⁰, carboxymethylcellulose sodium;
NaPS²¹, sodium persulfate;
NaSITE²², sodium sulfite;
NCN²³, ammonium cerium nitrate;
P²⁴, phosphorus;
PVA²⁵, polyvinyl alcohol;
PVP²⁶, polyvinylpyrrolidone;
SRF²⁷, slow release fertilizer

### Traditional Synthetic Hydrogels

Studies on hydrogel materials, their physicochemical properties, and agricultural applications can be traced back as early as the 1950s (Hiroshi et al., 1952). Traditional synthetic hydrogels encompass a range of materials with exceptional properties (Kopecek, 2007). Over the past few decades, these hydrogels have been successfully commercialized. Currently, the majority of hydrogel products available on the market for soil amendment fall under the category of traditional synthetic hydrogels, primarily due to their affordability, which has garnered popularity among consumers such as farmers and gardeners. The production process for traditional synthetic hydrogels typically involves the polymerization of high-purity monomers along with other chemicals (Table 1). The straightforward synthesis of these cost-effective hydrogels has contributed to their enduring appeal to manufacturers. Recent advancements in controlled radical polymerization techniques, such as atom transfer radical polymerization, have allowed for precise control over the chain lengths, sequences, and three-dimensional structures of hydrogels (Akhtar et al., 2016). These breakthroughs are propelling synthetic hydrogels toward becoming designer hydrogels, enabling them to exhibit more tailored performance characteristics in response to diverse environmental conditions.

Traditional synthetic hydrogels are commonly synthesized using acrylamide (AAm), acrylic acid (AA), and/or acrylate salts, which have demonstrated exceptional swelling and adsorption capacities, allowing them to rapidly absorb large amounts of water (Hosseini et al., 2021). These hydrogels share similar chemical structures, with hydrophilic groups such as —OH, —COOH, and —CONH₂ providing the driving forces to attract and retain water molecules from their surroundings (Pakdel & Peighambardoust, 2018). In general, hydrogels containing —COOH groups, such as polyacrylic acid (poly(AA)), exhibit higher water and solution absorption capabilities compared to those containing —CONH₂, such as polyacrylamide (poly(AAm)), but they are less tolerant to salts (Zhu et al., 2019). Crosslinkers, such as N,N′-methylenebisacrylamide (MBA), play a role in establishing the three-dimensional networks of synthetic hydrogels (Ahmed, 2015). A higher proportion of crosslinker in the polymer backbones generally provides hydrogels with increased stability and a longer lifetime, while a relatively smaller proportion often results in improved elasticity and swelling capacity (Lazzari et al., 2014). Additionally, certain inorganic compounds and/or clays can be incorporated during hydrogel synthesis to enhance the mechanical strength of swollen hydrogels (Zohourian & Kabiri, 2008).

### Biodegradable Synthetic Hydrogels

The development of biodegradable synthetic hydrogels aligns with the demand for sustainable and environmentally friendly soil amendments that have minimal negative impacts on the ecosystem. These hydrogels are expected to undergo biological degradation by soil microorganisms and/or chemical hydrolysis under natural conditions (Kabir et al., 2020). The end products of complete degradation are nontoxic compounds such as carbon dioxide (CO₂), nitrogen gas (N₂), and water (Luckachan & Pillai, 2011). In some examples, biodegradable synthetic hydrogels are based on natural polymers with large molecular weights, such as polysaccharides and proteins (Ni & Dumont, 2016; Qi et al., 2018). However, a small group of hydrogels utilizes synthetic biopolymers like aliphatic polyesters and polyphosphoesters (Tian et al., 2012). Polyvinyl alcohol (PVA) is one of the synthetic polymers that exhibits excellent biocompatibility, biodegradability, and hydrophilicity (Pang et al., 2011). In a recent study, researchers crosslinked PVA with polyethylene glycol (PEG) and sodium sulfate to synthesize environmentally benign polymeric hydrogels (Sarkar & Sen, 2018). The PVA-based hydrogels in this study efficiently retained and released water and incorporated urea in a slow manner, while also absorbing a high concentration of Fe(III) from agricultural fields (Sarkar & Sen, 2018).

### Hybrid Hydrogels

Hybrid hydrogels, also known as (semi-)interpenetrating polymer networks (IPNs), have emerged as a recent development to reduce the costs associated with biodegradable synthetic hydrogels. These hybrid systems consist of components from at least two distinct classes of molecules, such as synthetic polymers and biological macromolecules, interconnected either covalently or non-covalently (Kopecek & Yang, 2007). One approach to design and synthesize enzymatically degradable hydrogels is by combining synthetic polymers with sequences or chains of natural polymers that match the degradable sequences/chains with the active site of respective enzymes (Kopecek & Yang, 2007). The selection of natural polymer(s) plays a role in the successful synthesis of hydrogels (Thombare et al., 2018). Hybrid hydrogels may be semi-degradable, and their degradation products may be less degradable (Saruchi et al., 2019). Furthermore, certain monomers like acrylamide can be toxic to living organisms and have the potential to deteriorate soil quality (Xiong et al., 2018).

Polysaccharides, including cellulose and its various derivatives, chitosan, carrageenan, and xanthan, are among the most abundant natural polymers on Earth (Ali Bejenariu et al., 2009; Juarez-Maldonado et al., 2016; Olad et al., 2018a, 2018b; Wang et al., 2012). Cellulose is a syndiotactic linear polymer with a molecular repeating unit known as a d-anhydroglucopyranose ring (Li & Chen, 2020a). Different derivatives, such as carboxymethyl cellulose, hydroxyethyl cellulose, and methyl cellulose, can be obtained depending on the arrangement of the three hydroxyl groups attached to the ring. The solvents used for dissolving cellulose are typically toxic (Qiu & Hu, 2013), whereas the solvents for most cellulose derivatives are nontoxic or water-based, making them promising for agricultural applications (Chang & Zhang, 2011). Chitosan is a linear polymer composed of two repeating units, namely d-glucosamine and N-acetyl-d-glucosamine, in random orders (Juarez-Maldonado et al., 2016). Another readily available natural polymer is starch, which can be easily derived from plants (Nnadi & Brave, 2011). A recently developed hybrid hydrogel, synthesized through solution polymerization of sulfamic acid-modified starch and acrylic acid, exhibited a remarkably high swelling ratio of up to 1026 g/g in deionized water and 145 g/g in 0.9% sodium chloride solution (Zhao et al., 2019). In addition to the aforementioned polysaccharides, carrageenan (derived from seaweeds) (Wang et al., 2012) and xanthan (obtained through aerobic decomposition of sugar cane or corn by Xanthomonas campestris) (Bueno et al., 2013) are also good alternatives for high-performance hybrid hydrogels. Furthermore, protein-based materials such as collagen, gelatin, polypeptides, and amino acids have gained attention in recent years as potential monomers for synthesizing hydrogels (Irwansyah et al., 2014; Lu et al., 2016; Marandi et al., 2011; Thakur et al., 2017). The combination of diverse natural polymers with different synthetic polymers, coupled with emerging methods and technologies, holds great promise for the wide application of cost-effective and salt-tolerant hydrogels in agriculture and horticulture.

### Water Swelling and Nutrient Release Mechanisms and Models

The original function of hydrogels in agriculture was primarily focused on water storage and release. However, with advancements in polymer engineering and the increasing demand for agricultural production, hydrogels are now being combined with controlled/slow-release fertilizers to maximize their benefits (Ramli, 2019; Wu et al., 2021a). This section reviews mathematical models that describe the dynamic processes of hydrogel swelling and nutrient release when combined with controlled/slow-release fertilizers, aiming to uncover the underlying mechanisms.

The degree of swelling defines hydrogels in general (Thombare et al., 2018). The swelling behavior of hydrogels undergoes a transition from an unsolvated glassy polymer or partially rubbery state to a relaxed rubbery region (Ganji et al., 2010). This transition is predominantly controlled by various factors, including osmotic pressure, water capillary forces, and gel structure relaxation (Nascimento et al., 2021; Puoci et al., 2008). During the process of water swelling, the absorbed water gradually dissolves the inner core of the fertilizer, thereby facilitating the controlled release of the coated fertilizer (Tanan et al., 2021). The swelling capacity of a hydrogel is determined by the available space within its three-dimensional network to accommodate water. The release of nutrients through diffusion typically occurs simultaneously with partial dissolution and/or degradation of the hydrogel (Siegel & Rathbone, 2012).

### Swelling Forces of Hydrogels

The swelling of a crosslinked network in polymeric hydrogels is determined by the interactive forces between the hydrogel and water (Jabbari & Nozari, 2000). Generally, stronger interactions between the hydrogel and water are observed in more hydrophilic polymer structures (Jabbari & Nozari, 2000). When ionic groups are present in the network, osmosis occurs due to the counter ions, resulting from differences in ion concentrations between the interior and exterior interfaces (Ahmed, 2015). The osmotic pressure that arises becomes more significant with larger differences in ion concentrations (Ahmed, 2015). The three dimensional network expands considerably in space due to the repulsive forces generated by the ionic charges in the polymer backbone. This expanded space allows for water storage, and the numerous hydrophilic groups in the hydrogel contribute significantly to water adsorption (Ai et al., 2021).

Equilibrium Swelling of Hydrogels Modern theories of equilibrium hydrogel swelling have originated from the Flory-Rehner (FR) theory, which provides an explanation for gel swelling behavior based on the free energy change in the polymer-solution system (Flory & Rehner, 1943). The equilibrium swelling state is attained when osmotic pressure (Π) is equal to zero, as indicated by Eqs. (1) and (2).

$$Π = {Π}_{mix} + {Π}_{el} + {Π}_{ion} \qquad ( 1 )$$

$$Π = - {K}_{B} {Tv}^{- 1} [ ϕ + ln ( 1 - ϕ ) + {χϕ}^{2} ] + {n}_{c} {K}_{B} T [ ( ϕ / 2 {ϕ}_{0} ) - {( ϕ / {ϕ}_{0} )}^{1 / 3} ] + {K}_{B} T {\sum }_{i} ( {n}_{i}^{i n} - {n}_{i}^{out} ) \qquad ( 2 )$$

where Πmix is due to the mixing during polymer and solvent interaction; Πel is a result of polymer deformation; Πion is attributed to the ionic difference; n_{c} is the number of chains per unit volume at the reference state; K_{B} is the Boltzmann constant, 1.38×10⁻²³ m² kg s⁻² K⁻¹; Tis the absolute temperature (K); v is the molar volume of solvent; ϕ is the polymer network volume fraction; ϕ₀ is the polymer network volume fraction at the reference state; χ is the Flory-Huggins solubility parameter (a smaller χ indicates better transfer) (Quesada-Perez et al., 2011); and, nᵢⁱⁿ and nᵢ^{out} are the numbers of ions transferring in to and out of the polymer, respectively.

### Kinetic Models for Agricultural Applications

The swelling and release behaviors of hydrogels are generally reversible (Pakdel & Peighambardoust, 2018). According to the Fickian diffusion theory, three transport modes are defined in dynamic models: (1) Fickian/case I transport, where the solvent diffusion rate (R_{diff}) is slower than the stress relaxation rate (Rᵣₑₗₐₓ); (2) case II transport, characterized by rapid diffusion (R_{diff}>>Rᵣₑₗₐₓ); and (3) anomalous transport, when R_{diff} and Rᵣₑₗₐₓ are comparable (R_{diff}≈Rᵣₑₗₐₓ) (Frisch, 1980). Mathematical models are used in capturing the mechanisms underlying the swelling and release behaviors of hydrogels, including diffusion, dissolution, and/or erosion. The choice of transport model geometry should also be carefully considered. One-dimensional transport models can simplify the system, but their application may be limited, whereas three-dimensional transport models are more complex yet realistic. By assuming that the swelling and release processes are primarily driven by osmotic pressure and stress relaxation, different dynamic models have been developed to characterize and predict the performance of hydrogels under various environmental conditions.

### Water Swelling Models

The Korsmeyer-Peppas model (Eq. 3) is one of the most popular models for agricultural applications of hydrogels (Siepmann & Peppas, 2012).

$${M}_{t} / {M}_{0} = {K}_{S} {t}^{n} \qquad ( 3 )$$

where Mₜ is the mass of absorbed water after a contact time of t; Mₒ is the water mass at equilibrium; K_{S} is the swelling/release rate constant; and n is the diffusion/release exponent. The transport mode for slab hydrogels can be determined according to the n value, i.e., n<0.5, Fickian/case I transport; 0.5≤n<1, anomalous transport; n≥1, case II transport. Other hydrogel geometries (e.g., sphere or cylinder) may have different boundary values of n (Siepmann & Peppas, 2012).

The Korsmeyer-Peppas model has demonstrated reliable predictive capabilities for hydrogel water swelling within the initial 60% of the diffusion profile (Mₜ/Mₒ≤0.6) (Siepmann & Peppas, 2012). However, its accuracy may gradually diminish beyond this range. Subsequent studies have revealed that assuming a constant value for n in the model cannot adequately describe the influence of varying osmotic pressure on the swelling and release behaviors of hydrogels (Sarkar et al., 2019).

The Schott model (Eq. 4) serves as a valuable complement to the Korsmeyer-Peppas model, offering an extension of water swelling prediction to the upper 40% of the diffusion profile (i.e., Mₜ/Mₒ>0.6) (Schott, 1992). This pseudo-second-order model provides additional insights and a more comprehensive understanding of the swelling behavior of hydrogels.

$$t / {M}_{t} = t / {K}_{Si} + ( 1 / {M}_{0} ) t \qquad ( 4 )$$

where K_{Si} is defined as the initial swelling rate constant, K_{Si}=K_{S}M².

The Schott model is commonly utilized for evaluating the swelling kinetics of hydrogels, as observed in various studies (Ganji et al., 2010). Furthermore, recent research has demonstrated the effectiveness of the Schott model in simulating the performance of novel wheat straw cellulose-based hydrogels and assessing the influence of ions (Liu et al., 2014). In addition to the Schott model, another less frequently employed yet simple model (Eq. (5)) was developed by Yiamsawas et al. based on the Fick's law (Yiamsawas et al., 2007).

$${M}_{t} / {M}_{0} = 1 - {e}^{- {K}_{s}} \text{?} \qquad ( 5 )$$

$$\text{?} \text{indicates text missing or illegible when filed}$$

The Yiamsawas model displayed a good fitting for the water swelling behavior of acrylamide-crotonic acid superabsorbent polymers (SAPs) with varying crosslinker concentrations (Yiamsawas et al., 2007). Due to its robustness, the Yiamsawas model shows promise in simulating SAPs used for adsorbing ionic dyes in the textile industry (Yiamsawas et al., 2007).

### Nutrient Release Models

In the case of coating fertilizers, the release pattern of nutrients from hydrogels is often influenced by limiting factors such as diffusion rates, swelling, and sometimes erosion (Bajpai et al., 2008). To achieve desirable storage and release of dissolved nutrients, hydrogels possess crosslinked networks with enhanced water swelling capacity and mechanical properties (Siepmann & Peppas, 2012). Initially developed for drug delivery processes, most release models based on the Fickian diffusion theory were later adapted for agricultural applications (Chang & Zhang, 2011; Ganji et al., 2010).

The Higuchi model (Eq. 6), characterized by the release factor (Kᵣ) and the square root of time (t^{1/2}), was the first model developed for drug release (Higuchi, 1963):

$${M}_{t} / {M}_{0} = {K}_{r} {t}^{1 / 2} \qquad ( 6 )$$

However, the Higuchi model assumes a constant, one-dimensional, and sole diffusion system, which is often too idealized for real-world situations. As a result, inconsistencies between the modeling results and experimental data have been reported in many previous studies (Sarkar et al., 2014).

Built upon the Higuchi model, the first-order model (Eq. 7) has been widely used for nutrient release (Arafa et al., 2022).

$${M}_{t} / {M}_{0} = {( {M}_{t} / {M}_{0} )}_{max} [ 1 - {e}^{- {K}_{r} i} ] \qquad ( 7 )$$

where Kᵣ is the first-order release constant; (Mₜ/Mₒ)max is maximum value of cumulative release at time t and infinite time.

The Gallagher-Corrigan model (Eq. 8) is one of the most widely used models (Gallagher & Corrigan, 2000). Unlike the previous models, this model divides the release into two phases, i.e., biphasic release consisting of a first-order quick burst and a smooth release controlled by polymer degradation.

$${M}_{t} / {M}_{0} = {( {M}_{t} / {M}_{0} )}_{B} [ 1 - {e}^{- K} \text{?} ] + [ {( {M}_{t} / {M}_{0} )}_{max} - {( {M}_{t} / {M}_{0} )}_{B} ] [ e \text{?} / ( 1 + e \text{?} ) ] \qquad ( 8 )$$

$$\text{?} \text{indicates text missing or illegible when filed}$$

where (Mₜ/Mₒ)B is the cumulative release in Stage I; K₁ᵣ and K₂ᵣ are the release factors in Stage I and Stage II, respectively; (Mₜ/Mₒ)max is the maximum release during the process.

In this model, (Mₜ/Mₒ)B represents the fraction resulting from the dissolution of nutrient domains located on the surface of the polymer-nutrient compact. This fraction tends to increase as the nutrient particle size increases. The increase in (Mₜ/Mₒ)B with higher loading is attributed to the aggregation of dispersed nutrient particles, which effectively increases the proportion of nutrients linked to the compact surface.

While several other models, such as the zero-order model (Balcerzak & Mucha, 2010), Weibull model (Fu & Kao, 2010), and Alfrey model (Singh et al., 2006), have been developed in recent years, they are less commonly used in agricultural hydrogel applications due to their unsatisfactory accuracy, complex parameter input, and other limitations. Furthermore, an increasing number of studies have started to focus on technologies that enable simultaneous nutrient release and hydrogel degradation (Bauli et al., 2021; Ni et al., 2011; Rizwan et al., 2021). However, fewer studies have investigated the release pattern behavior considering the impacts of hydrogel degradation. This type of controlled fertilizer release aligns with the growing interest in sustainable agriculture (Fertahi et al., 2021). In Sect. 3.3.3, we have included one preliminary model that examines the behavior of nutrient release and hydrogel degradation as a unit.

### Comprehensive Diffusion-Swelling-Erosion Model

Unlike the simple swelling and release models discussed above, the comprehensive model (Eqs. (9)-(12)) assumes that the functioning of hydrogel consists of water swelling, nutrient release, and matrix erosion, and thus, it takes the three processes into account at the same time (Saeidipour et al., 2017).

$$Diffusion \partial {C}_{K} / \partial t = \partial / \partial r ( {D}_{k} \partial {C}_{K} / \partial r ) + {D}_{k} / r \partial {C}_{K} / \partial r + \partial / \partial z ( {D}_{k} \partial {C}_{K} / \partial z ) \qquad ( 9 )$$

$${D}_{k} = {D}_{keq} {e}^{[ - {β}_{k} ( 1 - {C}_{k} / {C}_{k , eq} ) ]} \qquad ( 10 )$$

$$Swelling V = {M}_{t} [ {ω}_{1} / {ρ}_{1} + {ω}_{2} / {ρ}_{2} + 1 - ( {ω}_{1} + {ω}_{2} ) / {ρ}_{3} ] \qquad ( 11 )$$

$$Matrix Erosion \partial {M}_{P} / \partial t = - {K}_{erosion} {A}_{t} \qquad ( 12 )$$

where Cₖ is the concentration of either water or nutrient; t is time; r and z are the radical and axial coordinates, respectively; D_{K} is the diffusion parameter; D_{Keq} is the diffusion at equilibrium; βₖ is a functional constant determined from experimental data simulation; C_{k,eq} is the concentration of either water or nutrient at equilibrium; V is the swelling of hydrogel; ω₁ and ω₂ are the weight fraction of water and nutrient, respectively; ρ₁, ρ₂ and ρ₃ are the density fraction of water, nutrient and hydrogel, respectively; Mₜ is the weight of hydrogel at time t; Mₚ is the dry matrix weight at time t; Kₑᵣₒₛᵢₒₙ is the erosion constant derived from experimental data; and, Aₜ is the available surface area at time t.

The differential equations in this comprehensive model are typically solved using multiparadigm numerical computing software such as MATLAB, SPSS, or AP-CAD. The application of this comprehensive mathematical model allows for the prediction of hydrogel matrix behavior under more complex and realistic conditions. Additionally, this model can be used to formulate the desired nutrient release profile, which is valuable for designing new controlled release matrices and improving the system geometry and dimensions of hydrogels. By utilizing this model, researchers can gain insights into the performance and optimization of hydrogel-based systems in a more efficient and targeted manner.

### Hydrogels as Water Reservoirs in Agricultural Fields

Due to the swelling capacity of hydrogels, their applications in various agricultural fields have shown significant improvements in plant growth and crop yields over the past decade (Table 2). In these recent studies, different indicators were utilized to evaluate hydrogel performance, including water conservation, evapotranspiration rate, seed germination, plant weight, and more. In some examples, the choice of indicator can impact the evaluation of hydrogel performance.

In this review, the increases in biomass yield and soil moisture content were employed to compare the efficacy of different hydrogels as soil amendments in agriculture (Table 2). Regardless of the indicator used, the benefits of applying hydrogels in agricultural fields were generally significant, although the effects varied depending on the specific hydrogel and plant species. It is worth noting that adverse effects have also been observed in certain cases. For instance, the use of guar gum cellulose-based hydrogels in a Chinese cabbage field led to a 14.17% decrease in production due to the already high water content in the untreated soil (Li et al., 2013). Further increasing the soil moisture content limited oxygen availability in the rhizosphere, which was unfavorable for plant growth (Montesano et al., 2015). Root biomass and cumulative root length in soil amended with hydrogel were significantly lower than in untreated soil (Watcharamul et al., 2022).

The performance of hydrogels is influenced by various factors, including hydrogel properties, pH, ionic strength, and others, which will be discussed later in this section. Table 2 displays hydrogel products from seven manufacturers, with three of them based in China. Additionally, three biodegradable hydrogels, which are more environmentally friendly with reduced ecological footprints, have been employed in practice. The utilization of emerging cellulose-based hydrogels and hybrid hydrogels points toward a more sustainable future for hydrogel applications, aiming to reduce irrigation needs and enhance agricultural production.

### Effects of Hydrogel Properties on Water Swelling and Retention

Hydrophilic groups present within the crosslinked networks of hydrogels are the primary contributors to water swelling (Akhtar et al., 2016). A higher density of hydrophilic groups typically results in a more pronounced ability to attract and retain excess water in agricultural soils (Puoci et al., 2008). Hydrogels with stronger hydrophilic groups such as —COO demonstrate superior water swelling capacity compared to those with relatively weaker groups like —CONH₂ (Zhu et al., 2019). Based on this finding, when producing cellulose based hydrogels, minimizing the dosage of cellulose as it usually contains fewer hydrophilic groups. Although the presence of cellulose and its derivatives in hydrogels can enhance crosslinking and certain mechanical properties, it may decrease the density of hydrophilic groups.

The degree of crosslinking is another relevany property of hydrogels that predominantly determines their performance as water reservoirs. Crosslinkers render a hydrogel unit insoluble in water and can improve its elastic modulus (Ravishankar & Dhamodharan, 2020). If the degree of crosslinking is low (e.g., <0.1%), the three-dimensional networks of the hydrogel may easily collapse, leading to a loss of its water-holding capacity (Kong et al., 2019). Conversely, if crosslinkers are overdosed (e.g., >0.5%), the elasticity of the hydrogel can be limited, thereby reducing its swelling capacity (Wang et al., 2016). The optimal degree of crosslinking for a hydrogel primarily depends on the properties of its monomers (Ahmed, 2015).

Traditional chemical crosslinkers are typically toxic and slowly degradable in the environment (Ullah et al., 2015) and can be replaced with biodegradable crosslinkers extracted from natural resources (Sabadini et al., 2022). For instance, when citric acid is used to crosslink starch backbones, the resulting biodegradable hydrogel exhibits outstanding water swelling and retention capacity (Bueno et al., 2013). Hydrogels crosslinked by citric acid demonstrate superior performance compared to other xanthan-based hydrogels due to the abundance of carboxylic groups that undergo esterification (Bueno et al., 2013). Another alternative is the use of physical crosslinking techniques such as hydrophobic interaction, conjunction, freezing and thawing, radiation, and more (Kumar et al., 2023; Tuncaboylu et al., 2011). These innovative techniques have been widely employed in the production of drug-delivery hydrogels and hold promising potential for agricultural hydrogels in the future.

TABLE 2
Field applications of various hydrogels and their performance.

| | | | | | Dry | Dry | | | | |
|---|---|---|---|---|---|---|---|---|---|---|
| | | Application | Maximum | | biomass | biomass | | | | |
| | | rate of | water | | yield w/o | yield w/ | Increase | Increase of | Price of | |
| Hydrogel | | hydrogel | adsorption | | hydrogel | hydrogel | of biomass | soil water | Hydrogel | |
| Monomer | Manufacturer | (g/kg soil) | (g/g) | Plant type | (g/m²/day) | (g/m²/day) | yield (%) | content (%) | ($/kg) | References |
| KA + AA | *BASF | 2 | — | Grass Seeds | 0.55 | 0.72 | 30 | 25 | 2.9 | Agaba et al. |
| | | 4 | | (Agrostis | | 1.82 | 231 | 65 | | (2011) |
| | | | | stolonifera) | | | | | | |
| KA + AA | BASF | 2 | — | Tree seeds | 0.11 | 0.19 | 76 | — | 2.9 | Hüttermann |
| | | 4 | | (Grevillea | | 0.27 | 150 | | | et al. (2009) |
| | | | | robusta) | | | | | | |
| AAm + | Rahab Resin | 2 | 200 | Corn (Zea | 0.042 | 0.07 | 75 | 158 | N/A | Dorraji et |
| KA + AA | | | | mays L.) | | | | | | al., (2010) |
| | | 6 | | | | 0.06 | 32 | 106 | | |
| KA + AA | Stockhausen; | 1.35 | — | Wheat | 0.63 | 0.66 | 4 | 41 | N/A; | Dehkordi, |
| | BASF | | | (Triticum | | 0.84 | 31 | 46 | 2.9 | (2018) |
| | | | | aestivum L.) | | | | | | |
| AAm | — | 0.45 | — | Oat (Avena | 0.06 | 0.07 | 25 | 4 | | Islam et al. |
| | | | | sativa L.) | | | | | | (2011b) |
| AAm+ | Han Limiao | 0.075 | — | Winter Wheat | 22.41 | 27.26 | 22 | — | N/A | Islam et al. |
| Potassium | (Beijing) | 0.15 | | (Triticum | | 30.95 | 38 | — | | (2011a) |
| salt | | | | | | | | | | |
| | | 0.225 | | aestivum L.) | | 39.09 | 74 | — | | |
| | | 0.3 | | | | 43.83 | 96 | — | | |
| Guar gum | RHODIA | 0.1 | — | Chinese | 0.54 | 0.44 | −14 | 22 | 13.2 | Li et al., |
| | | | | Cabbage | 0.09 | 0.10 | 6 | 25 | | (2013) |
| | | | | (Brassica | 0.01 | 0.02 | 51 | 19 | | |
| | | | | chinensis) | | | | | | |
| Hybrid | Dong Ying | 0.225 | 500-600 | Tomato | 6.55 | 7.02 | 7 | — | N/A | Hou et al. |
| hydrogel | Hua Ye New | 0.45 | 300-400 | | — | — | 57 | — | | (2018) |
| | Material | 0.675 | 300-400 | | — | 10.22 | — | — | | |
| AAm + | — | 3 | 125 | Guava | — | — | 31 | 250 | N/A | Abdallah |
| Potassium | | | 172 | (Psidium | | — | 82 | 188 | | (2019) |
| salt | | | 195 | guajava L.) | | — | 109 | 163 | | |
| AA + Am + | — | 7 | 190 | Green Pea | 4.14 | 4.97 | 20 | — | N/A | Riad et al. |
| CMC | | | | (Pisum | | 6.21 | 50 | | | (2017) |
| | | | | sativum L.) | | | | | | |
| NaCMC + | — | 10 | — | Cucumber | 26.09 | 50.09 | 92 | 48 | N/A | Montesano |
| HEC | | 20 | | Plants | | | | 28 | | et al. (2015) |
| NaCMC + | — | 2 | 82 | Cherry | — | — | 63 | — | N/A | Demitri et |
| HEC | | 5 | | Tomato | | | 113 | | | al. (2013) |
| CMC | — | 40 | 30 | Corn (Zea | 3.48 | 2.73 | −22 | — | N/A | Watcharam |
| | | 80 | | mays L.) | | 2.12 | −39 | 21 | | ul et al. |
| | | 40 | | | | 3.79 | 9 | — | | (2022) |
| | | 80 | | | | 2.73 | −22 | 29 | | |
| AA | Evonik | 1.5 | 374 | Corn (Zea | 14.43 | 27.58 | 91 | 52 | N/A | Abdallah |
| | Corporation | 3.0 | | mays L.) | | 38.84 | 169 | 78 | | et al. (2021) |
| | | 4.5 | | | | 15.87 | 10 | 113 | | |
| AAm | Hydrosource, | 1.5 | 238 | Corn (Zea | 14.43 | 33.60 | 133 | 41 | 7 | Abdallah et |
| | LLC | 3.0 | | mays L.) | | 42.24 | 193 | 70 | | al. (2021) |
| | | 4.5 | | | | 47.20 | 227 | 91 | | |
| AA + AAM | Iramont Inc. | 1.5 | 250 | Corn (Zea | 14.43 | 22.76 | 58 | 41 | N/A | Abdallah et |
| | | 3.0 | | mays L.) | | 34.33 | 1385 | 63 | | al. (2021 |
| | | 4.5 | | | | 40.13 | 178 | 83 | | |
| Aam | Moisture Plus | 0.5 | 355 | Corn (Zea | 22.68 | 21.89 | 3 | 13 | 21.3 | Zhao et al. |
| | Watering | | | mays L.) | | | | | | (2022) |
| | Crystals, USA | | | | | | | | | |
| Starch + AA | — | 0.5 | 515 | Corn (Zea | 22.68 | 22.68 | −3 | 11 | N/A | Zhao et al. |
| | | | | mays L.) | | | | | | (2022) |
| Sulfamic | — | 0.5 | 1085 | Corn (Zea | 22.68 | 22.68 | 0.7 | 19 | N/A | Zhao et al. |
| Acid + | | | | mays L.) | | | | | | (2022) |
| Starch + AA | | | | | | | | | | |

*Price listed for 1000 kg, which represents the manufacturing price rather than the commercial price available to the general public

### Effects of pH and Iconic Strength on Water Swelling and Retention

Soil pH typically ranges from 5 to 8 in most agricultural fields (Jeffery et al., 2011). The effectiveness of hydrogels can significantly vary in response to different pH levels. In an acidic (low pH) environment, hydrophilic groups such as —COO— become saturated with protons through hydrogen bonds, hindering the hydrogel's ability to attract and retain water. Slightly alkaline environments are generally optimal for hydrogels because weak repulsive forces can enlarge the void spaces in the hydrogel network (Li et al., 2004). However, in highly alkaline soils (pH>9), strong repulsive forces between unsaturated functional groups and the screening effect of cations such as Na⁺ can disrupt the hydrogel structure and render it ineffective as a water reservoir (Chen & Chen, 2019; Liu et al., 2006). The tolerance to acidity and alkalinity varies among different types of hydrogels. For instance, polyacrylamide-based hydrogels that are rich in —CONH₂ groups show greater resistance to pH changes compared to those abundant in carboxylic groups (Lu et al., 2016). Biodegradable hydrogels based on polysaccharides have also demonstrated strong adaptability to different pH levels (Mishra et al., 2018). A recent study reported that cellulose-based hydrogels could effectively absorb water even in solutions with a high pH of up to 10 (Rop et al., 2019).

The significant negative impacts of ionic strength on the swelling behavior of hydrogels have also been observed in many studies (ZOHOURIAN and Kabiri, 2008). High ionic strength is typically associated with a high concentration of cations (e.g., Na⁺, Ca²⁺, Mg²⁺, Fe³⁺, and NH4+) and/or anions (e.g., Br⁻, I⁻, SO42−, Cl⁻ and NO3−). Ions with larger radius sizes tend to increase the ionic strength more easily (Li et al., 2017). When the ionic strength of a solution is high, it becomes more challenging for hydrogels to absorb the solution due to increased repulsive forces, as mentioned earlier. Larger-radius-size ions (e.g., Fe³⁺, Ca²⁺, NH4+, and SO42−) have also been found to face more difficulty entering the crosslinked structures (Raafat et al., 2012). Since soluble nutrients are in high demand in most agricultural systems, it is crucial to improve the effectiveness of hydrogels under high-ionic-strength conditions.

Data synthesis incorporating experimental results from multiple independent studies has revealed the significant and predictable effects of pH and ionic strength on the swelling capacities of different hydrogels (FIG. 1). To facilitate comparison across studies, we have converted the reported swelling ratios (g/g) to a unified unit called the relative swelling ratio (FIG. 1). The optimal condition for comparison was defined as the swelling ratio measured at pH 7 in deionized water, while the swelling ratio at any other condition (e.g., different pH or ionic strength) was reported as a relative number based on its respective optimal condition. Specifically, the relative swelling ratio was calculated as the swelling ratio at the specific condition divided by the swelling ratio at pH 7 in deionized water.

The hydrogel type, the highest swelling ratios were consistently observed within the pH range of 6 to 8 (FIG. 1a). Deviating from this pH range, either increasing or decreasing the pH led to a reduction in the swelling capacity of hydrogels (FIG. 1a). Furthermore, the swelling capacity of hydrogels, irrespective of their type, consistently decreased as the ionic strength increased (FIG. 1b). By synthesizing the pH and ionic strength data using a previously described method (Li & Chen, 2018a), the simulated trend lines clearly illustrate the influences of these two factors on the swelling capacity of hydrogels. The calculated R-square values (0.636 and 0.789) and p values (<0.0001) indicate that the swelling ratio of hydrogels can be predicted with greater accuracy if more data of the same hydrogel type are included in the simulations. Therefore, it is encouraged to conduct statistical analyses of hydrogel data in future studies to enhance our understanding of their behavior and properties.

### Effects of Other Factors on Water Swelling and Retention

In addition to the previously discussed factors, various external factors including the mode of irrigation, application rate of hydrogel, soil type, and crop type can significantly influence the effectiveness of hydrogels as water reservoirs in agricultural settings. These factors often interact in complex ways within real-world conditions.

The efficacy of hydrogel may be compromised when the irrigation amount is either excessive or insufficient (Huttermann et al., 2009). The water retention capacity of hydrogels is directly influenced by the available water in the surrounding environment. If the irrigation rate is too low, the water will be directly utilized by plants and not stored by hydrogels. Conversely, excessive irrigation renders hydrogel application unnecessary. However, during drought periods, hydrogels can store the excess water resulting from higher irrigation rates and serve as a water supply. In a recent study, the application of two different hydrogels effectively reduced net water demands and increased tomato yield by 7% and 57%, respectively (Hou et al., 2018). In practical scenarios, the use of hydrogels should be carefully evaluated in conjunction with complex irrigation regimes to maximize their benefits. Several aspects of irrigation management and its relationship with hydrogel efficacy have been extensively discussed, such as irrigation depths (Cavalcante et al., 2018), irrigation intervals (Suresh et al., 2018), and irrigation schedules (Singh et al., 2018).

The application rate of hydrogel also plays a role in its real-world implementation. Generally, agricultural production increases with higher application rates. For instance, grass seed biomass increased by 30.90% when the hydrogel was applied at 2 g/kg soil, but by 231% when applied at 4 g/kg soil (Agaba et al., 2011). However, for certain plant species, the optimal application rate may not necessarily be the highest. When 2 g/kg soil of hydrogel was applied to grow corn, the yield increased by 75%, whereas using 6 g/kg soil only resulted in a 32% yield increase (Dorraji et al., 2010). Similar outcomes were observed in cucumber production, where excessive hydrogel doses led to the storage of excessive water, reducing the availability of water for plant growth (Montesano et al., 2015). Consequently, the application rate of hydrogel needs to be carefully determined to avoid unnecessary waste and optimize crop production.

The performance of hydrogels can vary when applied to different soil types and depths.

### Hydrogels as Nutrient Reservoirs in Agricultural Fields

Slow- and Controlled-Release Fertilizers with Hydrogel Coating

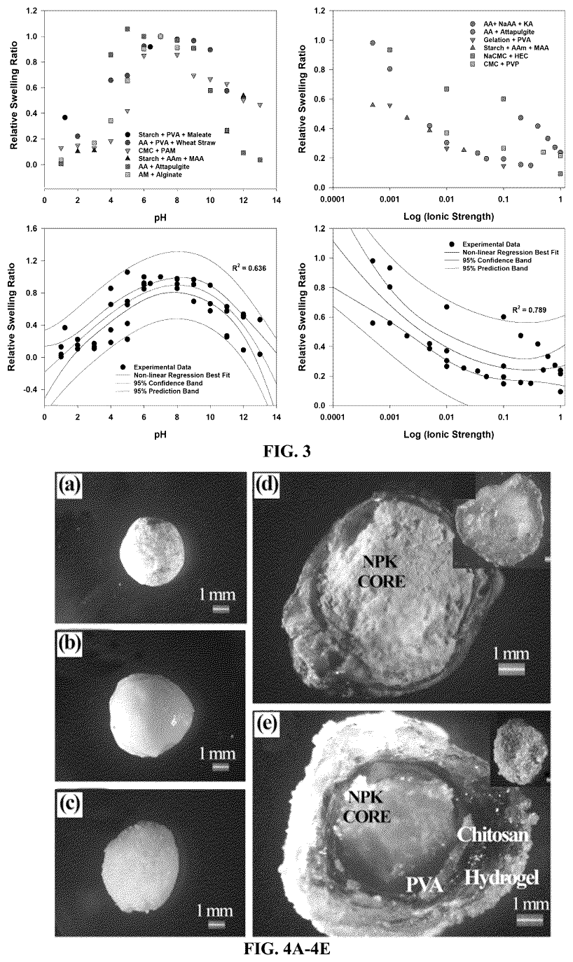

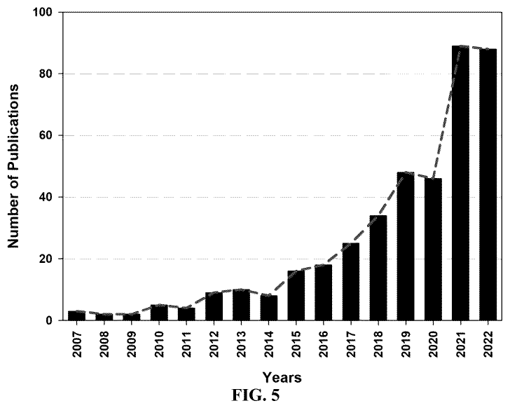

Conventional rapid-release fertilizers pose a significant risk of leaching into the environment, leading to ecological issues. To address this concern and enhance nutrient use efficiency, slow and controlled-release fertilizers (SRFs and CRFs) have been developed and widely adopted in agriculture. These fertilizers are not limited to a specific composition but encompass a range of novel fertilizers manufactured by coating conventional fertilizers with various organic/inorganic or polymeric materials (Jungsinyatam et al., 2022). In this review, we specifically focus on hydrogel-coated SRFs and CRFs, which have gained increasing attention in agricultural applications (Hosseini et al., 2021; Sarkar et al., 2019). Our investigation in Sect. 2 aligns with this trend, as a growing number of studies aim to combine biodegradable hydrogels with SRFs/CRFs to maximize soil amendment benefits while reducing economic and environmental burdens (Table 1). Typically, these fertilizers consist of a core containing essential plant nutrients (e.g., N, P, and K), which is then encapsulated by a hydrophilic crosslinked polymer with a precisely determined thickness (Noppakundilograt et al., 2015). Nutrient release from SRFs relies on the biodegradation of the polymer coating, whereas CRFs control release through osmotic pressure buildup inside the polymer coating as water diffuses in and dissolves the contained nutrients (Li & Chen, 2019). The rate of nutrient release is typically determined by the coating materials, layer thickness, and temperature. The polymer coating can be tailored to achieve desired properties for the SRF or CRF. For instance, a tri-layered CRF hydrogel was prepared by sequentially dipping NPK fertilizer granules into PVA and chitosan layers, followed by crosslinking the chitosan layer through glutaraldehyde vapor deposition (FIG. 4A-4E). After 30 days of water immersion, this hydrogel released 84±18% of N, 63±12% of P, and 36±15% of K, exhibiting a pseudo-Fickian diffusion mechanism described by the Korsmeyer-Peppas and Ritger-Peppas models (Noppakundilograt et al., 2015).

In recent years, an increasing number of novel SRFs and CRFs have been developed, with a focus on enhancing functionality under highly saline conditions and reducing the residual unreleased nutrients in the polymer matrices (Singh et al., 2019). Polymers synthesized using larger-molecular-weight monomers such as cellulose and starch have demonstrated improved tolerance to high salinity and extreme pH conditions (Ganguly et al., 2017; Lin et al., 2021). For example, a recently developed semi-interpenetrating network (semi-IPN) structure composed of acrylic acid and starch exhibited effective performance across a broad pH range (4.0-11.8), with optimal swelling observed at pH 8.6 (Ganguly et al., 2017). This study reported a nutrient release of approximately 85% over 21 days (Ganguly et al., 2017). To maximize the utilization of coated nutrients, researchers have explored biodegradable polymer coatings based on natural materials (Luckachan & Pillai, 2011). In a recent study, a cellulose-based fertilizer demonstrated high water absorption capacity, absorbing up to 1532 g/g of water under saline conditions (i.e., in a 0.3% (w/v) sodium salt solution), and releasing nearly 98% of the total nutrients (Qi et al., 2019). Additionally, some studies have investigated natural alternatives like biochar to enhance functionality and biodegradability. For instance, biochar-impregnated CRFs exhibited resistance to pH changes, increased water retention capacity by 67%, and gradually released N-P-K fertilizer over 45 days, fitting the Korsmeyer-Peppas model (Das & Ghosh, 2022).

### Effects of Hydrogel Properties on Nutrient Release

The choice of monomers and crosslinkers for polymer coating synthesis can result in contrasting nutrient-release behaviors (Chalk et al., 2015). In a recent study, fertilizer hydrogels (CRFs) were synthesized using acrylamide and itaconic acid with two different crosslinkers: ethylene glycol dimethacrylate (EGDMA) and N,N′-methylenbis-acrylamide (NMBA) (Urbano-Juan et al., 2019). EGDMA primarily interacted with the —COO— group, while NMBA targeted the —CONH— group. As a result, the CRFs crosslinked with EGDMA exhibited high water absorption of 2474 g/g with 93% nutrient release within 48 h, whereas those crosslinked with NMBA absorbed 650 g/g of water but released 97% of the nutrients (Urbano-Juan et al., 2019).

Another example involves the use of montmorillonite as one of the monomers in the synthesis of an acrylic acid-based slow-release urea fertilizer, which significantly increased water absorption (Olad et al., 2018a, 2018b). Presence of the fertilizer core may reduce the coating hydrogel's water absorption capacity but increase nutrient release. For instance, increasing the phosphorus dosage in a starch-based CRF resulted in reduced water absorption from 498 to 275 g/g, but a threefold increase in nutrient release (Zhong et al., 2013). Varying the dosages of different monomers and crosslinkers can also lead to diverse nutrient release patterns (Jamnongkan & Kaewpirom, 2010).

### Effects of Environmental Factors on Nutrient Release

The performance of nutrient release by fertilizer hydrogels is primarily influenced by various environmental factors, including pH, salinity, and temperature (Lu et al., 2016). For instance, a PVA/chitosan-based CRF showed an accumulative release of K ranging from 17 to 34% at a low pH of 4.1, while it ranged from 34 to 63% in a neutral pH environment (Jamnongkan & Kaewpirom, 2010). In the case of a cellulose-based CRF, optimal nutrient release (93%) was observed at a pH of 7, whereas it was 89.1% and 89.2% at pH values of 5 and 9, respectively (Chen & Chen, 2019). These effects can vary among different hydrogels. When different monomer contents were used to produce a cellulose-based CRF, the nutrient release varied from 74.3% to 83.6% at 25° C.

Another significant observation is that nutrient release was found to be more pronounced in water (e.g., 88%) compared to soil (e.g., 80%), primarily due to better solubility in water and higher ionic strength in soil (Ali Olad et al., 2018a, 2018b). Impacts of different environmental factors were considered when designing SRFs and CRFs for diverse agricultural applications.

### Current Concerns and Future Directions

### Economic Efficacy of Hydrogel Application in Agriculture

As agricultural practices are primarily driven by profitability, a major concern regarding the use of hydrogels in agriculture is whether their application will increase or decrease net profit. In any crop system, the output or profit is generated from the sale of crops, while the input or expenses include seeds, irrigation, fertilizers, machinery, power supply, labor, and more. While it is true that hydrogels add to the expenses of the system, their application can simultaneously reduce irrigation and fertilizer usage while increasing crop production (Puoci et al., 2008). This suggests the potential to lower overall expenses and achieve a higher net profit through the use of hydrogels in agricultural systems.

However, the discussion on the economic effectiveness of hydrogel application in agriculture is currently limited in the literature. A previous techno-economic analysis estimated the production cost of a starch-based controlled-release fertilizer to be 700 USD/t (Talaat et al., 2008). Assuming a sale price of 900 USD/t, applying hydrogels at a rate of 120 kg/acre (≈30,000 kg/km²) would result in an additional cost of 108 USD/acre (≈27,000 USD/km²) in an agricultural system. This additional cost could potentially be offset by the profits gained from increased crop yields and seed production (Talaat et al., 2008). However, this study did not provide information on the specific profits that could be recovered through the increased agricultural production facilitated by hydrogel application. In a recent four year field study, it was calculated that the application of hydrogels in Indian mustard production could lead to a higher profit of 3.31 USD/acre/day (approximately 820 USD/km²/day) compared to the control group, particularly under deficit irrigation scheduling (Jat et al., 2018). Unfortunately, there is still a lack of studies that employ systematic approaches, such as life-cycle cost analysis (LCCA), to thoroughly evaluate and highlight the economic viability of hydrogel application. LCCA is an effective and easily interpretable tool for determining the most cost-effective option among different competing alternatives, considering both current and future costs (Cheung et al., 2015). Although LCCA and techno-economic analysis are commonly used for economic evaluations in energy and other engineering systems, they are rarely applied to agricultural systems. Future studies should leverage these powerful tools and incorporate economic analyses into their experimental designs, whenever applicable, to provide comprehensive insights into the economic feasibility of hydrogel application in agriculture.

### Environmental Footprints of Hydrogel Application in Agriculture

The application of hydrogels in agriculture has raised concerns regarding their impact on the environment, particularly prior to the development of biodegradable hydrogels derived from natural raw materials (Nnadi & Brave, 2011). Intermediate and end products generated during hydrogel biodegradation should be non-toxic to soil biota and not accumulate in food chains. Rapid biodegradation is not preferable for agricultural use as the degraded polymer coating may fail to maintain the slow release of nutrients. On the other hand, limited biodegradation is also undesirable as partially degraded “resilient” small particles (<5 mm), including nanoplastics (<0.1 μm), could enter terrestrial ecosystems as “microplastics” and be transported far from the pollution source (Machado et al., 2018). The nature of hydrogels and the microplastics derived from them can influence soil physicochemical properties, such as texture and structure, leading to changes in water cycling, soil functioning, and plant-soil feedback (Bergmann et al., 2016). With the shifting baselines of physiological processes in terrestrial ecosystems, it is possible that some species, especially those with short generation times, may already be under evolutionary pressure from this new anthropogenic stressor (Machado et al., 2018).

The degradability of hydrogels primarily depends on the type(s) of monomer(s) used in their synthesis (Tian et al., 2012). Previous studies have shown that commonly used polyacrylamide hydrogels can be biodegraded by 31% within 7 days by Pseudomonas putida isolated from dewatered sludge (Yu et al., 2015). White-rot fungi (Phanerochaete chrysosporium) have been found to degrade polyacrylate, an intermediate product of polyacrylamide, although only 7% of the polymer was degraded after 76 days in one study (Nyyssölä & Ahlgren, 2019). However, only 7% of the polymer was degraded after 76 days in this study (Nyyssölä & Ahlgren, 2019). The sensitivity of fungal metabolism to soil properties, temperature, moisture, etc., can significantly impact the biodegradation process (Huttermann et al., 2009). The biodegradation of natural polymers has also been extensively studied. For example, gum tragacanth-based polymers can be degraded by 87% in 77 days (Saruchi et al., 2019). In another recent study, approximately 60% of hydrogels synthesized using chicken feather protein, PVA, and potassium acrylate were degraded in an agricultural soil incubated with Aspergillus niger, while 69% of nitrogen (N) and 64% of phosphorus (P) were released after 120 days (Kong et al., 2019). From an environmental persistence and sustainability standpoint, it appears that natural polymers are more suitable for future agricultural applications.

### CONCLUSION

With the increasing synthesis of environmentally friendly hydrogels in recent years, the applications of hydrogels in agriculture as water and nutrient reservoirs have garnered significant attention. Numerous prior studies have provided support for the positive effects of applying hydrogels in agricultural fields, including reduced irrigation and nutrient requirements, as well as enhanced crop production. Mathematical models have been developed to elucidate the mechanisms underlying water swelling and nutrient release behaviors of hydrogels, as well as to predict their performance under varying environmental conditions. Several diffusion models have effectively explained the slow and controlled release behavior of hydrogel-coated fertilizers. However, the development of more precise models that describe the diffusion and degradation phenomena during nutrient release is crucial to advance the sustainability of hydrogel-based agriculture.

Among the various factors influencing the effectiveness of agricultural hydrogels, pH and ionic strength have emerged as significant determinants in addition to the intrinsic properties of hydrogels. Moderate pH levels and low ionic strength generally favor optimal hydrogel performance. However, future hydrogel formulations must exhibit improved robustness to withstand rigorous environmental conditions and retain high effectiveness in agricultural soils. Despite the considerable number of hydrogel-related studies published each year, discussions regarding the economic benefits and environmental impacts of hydrogel usage in agriculture remain scarce or insufficiently addressed. Future research should embrace management tools such as life-cycle assessment and life-cycle cost analysis to comprehensively evaluate the sustainability of novel hydrogel applications. Moreover, the appropriate management and analysis of the abundant literature data through statistical techniques are urgently needed to unlock further insights in this field.

Other advantages which are obvious, and which are inherent to the invention, will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

### REFERENCES

Abdallah, A. M. (2019). The effect of hydrogel particle size on water retention properties and availability under water stress. International Soil and Water Conservation Research, 7(3), 275-285.
AbdAllah, A. M., Mashaheet, A. M., & Burkey, K. O. (2021). Super absorbent polymers mitigate drought stress in corn (Zea mays L.) grown under rainfed conditions. Agricultural Water Management, 254, 106946.
Abobatta, W. (2018). Impact of hydrogel polymer in agricultural sector. Advances in Agriculture and Environmental Science, 1(2), 59-64.
Agaba, H., Orikiriza, L. J. B., Obua, J., Kabasa, J. D., Worbes, M., & Huttermann, A. (2011). Hydrogel amendment to sandy soil reduces irrigation frequency and improves the biomass of Agrostis stolonifera. Agricultural Science, 02(04), 544-550.
Ahmed, E. M. (2015). Hydrogel: Preparation, characterization, and applications: A review. Journal of Advanced Research, 6(2), 105-121.
Ai, F., Yin, X., Hu, R., Ma, H., & Liu, W. (2021). Research into the super-absorbent polymers on agricultural water. Agricultural Water Management, 245, 106513.
Akalin, G. O., & Pulat, M. (2018). Preparation and characterization of nanoporous sodium carboxymethyl cellulose hydrogel beads. Journal of Nanomaterials, 2018, 1-12.
Akhtar, M. F., Hanif, M., & Ranjha, N. M. (2016). Methods of synthesis of hydrogels: A review. Saudi Pharmaceutical Journal, 24(5), 554-559.
Olad, A., Zebhi, H., Salari, D., Mirmohseni, A., & Tabar, A. R. (2018a). Slow-release NPK fertilizer encapsulated by carboxymethyl cellulose-based nanocomposite with the function of water retention in soil. Materials Science and Engineering, c: Materials for Biological Applications, 90, 333-340.
Alupei, I. C., Popa, M., Hamcerencu, M., & Abadie, M. J. M. (2002). Superabsorbant hydrogels based on xanthan and poly (vinyl alcohol): 1. The study of the swelling properties. European Polymer Journal, 38(11), 2313-2320.
Arafa, E. G., Sabaa, M. W., Mohamed, R. R., Kamel, E. M., Elzanaty, A. M., Mahmoud, A. M., & AbdelGawad, O. F. (2022). Eco-friendly and biodegradable sodium alginate/quaternized chitosan hydrogel for controlled release of urea and its antimicrobial activity. Carbohydrate Polymers, 291, 119555.
Bajpai, A. K., & Sharma, M. (2006). Preparation and characterization of novel pH-sensitive binary grafted polymeric blends of gelatin and poly(vinyl alcohol): Water sorption and blood compatibility study. Journal of Applied Polymer Science, 100(1), 599-617.
Bajpai, A. K., Shukla, S. K., Bhanu, S., & Kankane, S. (2008). Responsive polymers in controlled drug delivery. Progress in Polymer Science, 33(11), 1088-1118.
Balcerzak, J., & Mucha, M. (2010). Analysis of model drug release kinetics from complex matrices of polylactide-chitosan. Progress on Chemistry and Application of Chitin and Its Derivatives, 15, 117-126.
Bauli, C. R., Lima, G. F., de Souza, A. G., Ferreira, R. R., & Rosa, D. S. (2021). Eco-friendly carboxymethyl cellulose hydrogels filled with nanocellulose or nanoclays for agriculture applications as soil conditioning and nutrient carrier and their impact on cucumber growing. Colloids and Surfaces a: Physicochemical and Engineering Aspects, 623, 126771.
Bejenariu, A., Popa, M., Dulong, V., Picton, L., & Le Cerf, D. (2009). Trisodium trimetaphosphate crosslinked xanthan networks: Synthesis, swelling, loading and releasing behaviour. Polymer Bulletin, 62(4), 525-538.
Ben-Noah, I., & Friedman, S. P. (2016). Aeration of clayey soils by injecting air through subsurface drippers: Lysimetric and field experiments. Agricultural Water Management, 176, 222-233.
Bergmann, J., Verbruggen, E., Heinze, J., Xiang, D., Chen, B., Joshi, J., & Rillig, M. (2016). The interplay between soil structure, roots, and microbiota as a determinant of plant-soil feedback. Ecology and Evolution, 6, 7633-7644.
Bora, A., & Karak, N. (2022). Starch and itaconic acid-based superabsorbent hydrogels for agricultural application. European Polymer Journal, 176, 111430.
Bueno, V. B., Bentini, R., Catalani, L. H., & Petri, D. F. (2013). Synthesis and swelling behavior of xanthan based hydrogels. Carbohydrate Polymers, 92(2), 1091-1099.
Cavalcante, A. G., Cavalcante, L. F., Cavalcante, A. C., Souto, A. G. D. L., dos Santos, C. E., Araújo, D. L., & INCTSal, F. (2018). Variation of thermal time, phyllochron and plastochron in passion fruit plants with irrigation depth and hydrogel. Journal of Agricultural Science, 10(5), 229.
Chalk, P. M., Craswell, E. T., Polidoro, J. C., & Chen, D. (2015). Fate and efficiency of 15N-labelled slow and controlled-release fertilizers. Nutrient Cycling in Agroecosystems, 102(2), 167-178.
Chang, C. Y., & Zhang, L. N. (2011). Cellulose-based hydrogels: Present status and application prospects. Carbohydrate Polymers, 84(1), 40-53.
Chen, Y. C., & Chen, Y. H. (2019). Thermo and pH-responsive methylcellulose and hydroxypropyl methylcellulose hydrogels containing K₂SO₄ for water retention and a controlled-release water-soluble fertilizer. Science of the Total Environment, 655, 958-967.
Cheung, W. M., Marsh, R., Griffin, P. W., Newnes, L. B., Mileham, A. R., & Lanham, J. D. (2015). Towards cleaner production: A roadmap for predicting product end-of-life costs at early design concept. Journal of Cleaner Production, 87, 431-441.
Cruz, H., Luckman, P., Seviour, T., Verstraete, W., Laycock, B., & Pikaar, I. (2018). Rapid removal of ammonium from domestic wastewater using polymer hydrogels. Scientific Reports, 8, 1.
Das, S. K., & Ghosh, G. K. (2022). Hydrogel-biochar composite for agricultural applications and controlled release fertilizer: A step towards pollution free environment. Energy, 242, 122977.
Dehkordi, D. K. (2018). Evaluation of two types of superabsorbent polymer on soil water and some soil microbial properties. Paddy and Water Environment, 16(1), 143-152.
Demitri, C., Scalera, F., Madaghiele, M., Sannino, A., & Maffezzoli, A. (2013). Potential of cellulose-based superabsorbent hydrogels as water reservoir in agriculture. International Journal of Polymer Science, 2013, 1-6.
Di Lorenzo, F., & Seiffert, S. (2015). Nanostructural heterogeneity in polymer networks and gels. Polymer Chemistry, 6(31), 5515-5528.
Dorraji, S. S., Golchin, A., & Ahmadi, S. (2010). The effects of hydrophilic polymer and soil salinity on corn growth in sandy and loamy soils. Clean: Soil, Air, Water, 38(7), 584-591.
Fennell, E., & Huyghe, J. M. (2021). A three-dimensional mechano-electrochemical material model of mechanosensing hydrogels. Materials and Design, 198, 109340.
Fennell, E., Kamphus, J., & Huyghe, J. M. (2020). The importance of the mixing energy in ionized superabsorbent polymer swelling models. Polymers, 12(3), 609.
Fertahi, S., Ilsouk, M., Zeroual, Y., Oukarroum, A., & Barakat, A. (2021). Recent trends in organic coating based on biopolymers and biomass for controlled and slow release fertilizers. Journal of Controlled Release, 330, 341-361.
Flory, P. J., & Rehner, J. (1943). Statistical mechanics of cross-linked polymer networks II Swelling. The Journal of Chemical Physics, 11, 521-526.
Frisch, H. L. (1980). Sorption and transport in glassy polymers-A review. Polymer Engineering and Science, 20(1), 2-13.
Fu, Y., & Kao, W. J. (2010). Drug release kinetics and transport mechanisms of non-degradable and degradable polymeric delivery systems. Expert Opinion on Drug Delivery, 7(4), 429-444.
Gallagher, K. M., & Corrigan, O. I. (2000). Mechanistic aspects of the release of levamisole hydrochloride from biodegradable polymers. Journal of Controlled Release, 69, 261-271.
Ganguly, S., Maity, T., Mondal, S., Das, P., & Das, N. C. (2017). Starch functionalized biodegradable semiIPN as a pH-tunable controlled release platform for memantine. International Journal of Biological Macromolecules, 95, 185-198.
Ganji, F., Vasheghani-Farahani, S., & Vasheghani-Farahani, E. (2010). Theoretical description of hydrogel swelling: A review. Iranian Polymer Journal, 19(5), 375-398.
Garduque, R. G., Gococo, B. J., Yu, C. A., Nalzaro, P. J., & Tumolva, T. (2020). Synthesis and characterization of sodium carboxymethyl cellulose/sodium alginate/hydroxypropyl cellulose hydrogel for agricultural water storage and controlled nutrient release (pp. 51-57). Trans Tech Publ.
Godbole, R. V., Khabaz, F., Khare, R., & Hedden, R. C. (2017). Swelling of random copolymer networks in pure and mixed solvents: Multi-component Flory-Rehner theory. The Journal of Physical Chemistry B, 121(33), 7963-7977.
Guilherme, M., Reis, A., Paulino, A., Moia, T., Mattoso, L., & Tambourgi, E. (2010). Pectin-based polymer hydrogel as a carrier for release of agricultural nutrients and removal of heavy metals from wastewater. Journal of Applied Polymer Science, 117(6), 3146-3154.
Guilherme, M. R., Aouada, F. A., Fajardo, A. R., Martins, A. F., Paulino, A. T., Davi, M. F. T., Rubira, A. F., & Muniz, E. C. (2015). Superabsorbent hydrogels based on polysaccharides for application in agriculture as soil conditioner and nutrient carrier: A review. European Polymer Journal, 72, 365-385.
Gurevitch, J., Koricheva, J., Nakagawa, S., & Stewart, G. (2018). Meta-analysis and the science of research synthesis. Nature, 555, 175-182.
Hashmi, S. M., & Dufresne, E. R. (2009). Mechanical properties of individual microgel particles through the deswelling transition. Soft Matter, 5(19), 3682-3688.
Hennink, W. E., & van Nostrum, C. F. (2012). Novel crosslinking methods to design hydrogels. Advanced Drug Delivery Reviews, 64, 223-236.
Hertle, Y., Zeiser, M., Hasenohrl, C., Busch, P., & Hellweg, T. (2010). Responsive P(NIPAM-co-NtBAM) microgels: Flory-Rehner description of the swelling behaviour. Colloid and Polymer Science, 288(10-11), 1047-1059.
Higuchi, T. 1963. Mechanism of sustained-action medication. Theoretical analysis of rate of release of solid drugs dispersed in solid matrices. Journal of Pharmaceutical Sciences 52(12), 1145-1149.
Hiroshi, F., Kazuhiko, N., & Terutake, H. (1952). Mechanical properties of concentrated hydrogels of agaragar. I. Modulus of elasticity in compression. Bulletin of the Chemical Society of Japan, 25, 374-378. Hosseini, S. H., Niyungeko, C., Khan, S., & Liang, X. (2021). Effects of superabsorbent polyacrylamide hydrogel and gypsum applications on colloidal phosphorus release from agricultural soils. Journal of Soils and Sediments, 21(2), 925-935.
Hou, X., Li, R., He, W., Dai, X., Ma, K., & Liang, Y. (2018). Superabsorbent polymers influence soil physical properties and increase potato tuber yield in a dry-farming region. Journal of Soils and Sediments, 18(3), 816-826.
Huttermann, A., Orikiriza, L. J. B., & Agaba, H. (2009). Application of superabsorbent polymers for improving the ecological chemistry of degraded or polluted lands. Clean: Soil, Air, Water, 37(7), 517-526.
Irwansyah, I., Li, Y., Shi, W., Qi, D., Leow, W., Tang, M., Li, S., & Chen, X. (2014). Gram-positive antimicrobial activity of amino acid-based hydrogels. Advanced Materials, 27(4), 648-654.
Islam, M. R., Hu, Y., Fei, C., Qian, X., Eneji, A. E., & Xue, X. (2011a). Application of superabsorbent polymer: A new approach for wheat (Triticum aestivum L.) production in drought-affected areas of northern China. Journal of Food, Agriculture and Environment, 9(1), 304-309.
Islam, M. R., Xue, X., Mao, S., Ren, C., Eneji, A. E., & Hu, Y. (2011b). Effects of water-saving superabsorbent polymer on antioxidant enzyme activities and lipid peroxidation in oat (Avena sativa L.) under drought stress. Journal of the Science of Food and Agriculture, 91(4), 680-686.
Jabbari, E., & Nozari, S. (2000). Swelling behavior of acrylic acid hydrogels prepared by γ-radiation crosslinking of polyacrylic acid in aqueous solution. European Polymer Journal, 36(12), 2685-2692. Jamnongkan, T., & Kaewpirom, S. (2010). Potassium release kinetics and water retention of controlled release fertilizers based on chitosan hydrogels. Journal of Polymers and the Environment, 18(3), 413-421.
Jat, A. L., Rathore, B. S., Desai, A. G., & Shah, S. K. (2018). Production potential, water productivity and economic feasibility of Indian mustard (Brassica juncea) under deficit and adequate irrigation scheduling with hydrogel. Indian Journal of Agricultural Science, 88(2), 212-215.
Jeffery, S., Verheijen, F. G. A., Van der Velde, M., & Bastos, A. C. (2011). A quantitative review of the effects of biochar application to soils on crop productivity using meta-analysis. Agriculture Ecosystems and Environment, 144(1), 175-187.
Ji, Z., Pei, T., Chen, Y., Wu, H., Hou, Q., Shi, F., Xie, B., & Zhang, J. (2022). The driving factors of grassland water use efficiency along degradation gradients on the Qinghai-Tibet Plateau, China. Global Ecology and Conservation, 35, e02090.
Juarez-Maldonado, A., Ortega-Ortiz, H., Perez-Labrada, F., Cadenas-Pliego, G., & Benavides-Mendoza, A. (2016). Cu Nanoparticles absorbed on chitosan hydrogels positively alter morphological, production, and quality characteristics of tomato. Journal of Applied Botany and Food Quality, 89, 183-189.
Jungsinyatam, P., Suwanakood, P., & Saengsuwan, S. (2022). Multicomponent biodegradable hydrogels based on natural biopolymers as environmentally coating membrane for slow-release fertilizers: Effect of crosslinker type. Science of the Total Environment, 843, 157050.
Kabir, E., Kaur, R., Lee, J., Kim, K.-H., & Kwon, E. E. (2020). Prospects of biopolymer technology as an alternative option for non-degradable plastics and sustainable management of plastic wastes. Journal of Cleaner Production, 258, 120536.
Kabiri, K., & Zohuriaan-Mehr, M. J. (2003). Superabsorbent hydrogel composites. Polymers for Advanced Technologies, 14(6), 438-444.
Kenawy, E.-R., Seggiani, M., Hosny, A., Rashad, M., Cinelli, P., Saad-Allah, K. M., El-Sharnouby, M., Shendy, S., & Azaam, M. M. (2021). Superabsorbent composites based on rice husk for agricultural applications: Swelling behavior, biodegradability in soil and drought alleviation. Journal of Saudi Chemical Society, 25(6), 101254.
Kim, S., Iyer, G., Nadarajah, A., Frantz, J. M., & Spongberg, A. L. (2010). Polyacrylamide hydrogel properties for horticultural applications. International Journal of Polymer Analysis and Characterization, 15(5), 307-318.
Kim, Y. G., Lee, C. H., & Bae, Y. C. (2014). Hydrophilic-hydrophobic copolymer nano-sized particle gels: Swelling behavior and dependence on crosslinker chain length. Fluid Phase Equilibria, 361, 200-207.
Kong, W., Li, Q., Li, X., Su, Y., Yue, Q., & Gao, B. (2019). A biodegradable biomass-based polymeric composite for slow release and water retention. Journal of Environmental Management, 230, 190-198.
Kopecek, J. (2007). Hydrogel biomaterials: A smart future? Biomaterials, 28(34), 5185-5192.
Kopecek, J., & Yang, J. (2007). Hydrogels as smart biomaterials. Polymer International, 56(9), 1078-1098.
Kotkin, J. (2010). The next hundred million: America in 2050. Penguin Press.
Kumar, S., Tiwari, A., Chaudhari, C. V., & Bhardwaj, Y. K. (2023). Chitosan based radiation crosslinked and grafted matrix: An environment friendly adsorbent for dye uptake. Radiation Physics and Chemistry, 208, 110876.
Lazzari, S., Pfister, D., Diederich, V., Kern, A., & Storti, G. (2014). Modeling of acrylamide/N, N′-methylenebisacrylamide solution copolymerization. Industrial and Engineering Chemistry Research, 53(22), 9035-9048.
Li, A., Wang, A., & Chen, J. (2004). Studies on poly(acrylic acid)/attapulgite superabsorbent composites.
II. Swelling behaviors of superabsorbent composites in saline solutions and hydrophilic solvent-water mixtures. Journal of Applied Polymer Science, 94(5), 1869-1876.
Li, S., & Chen, G. (2018a). Factors affecting the effectiveness of bioelectrochemical system applications: Data synthesis and meta-analysis. Batteries, 4(3), 34.
Li, S., & Chen, G. (2018b). Using hydrogel-biochar composites for enhanced cadmium removal from aqueous media. Material Science and Engineering International Journal, 2(6), 294-298.
Li, S., & Chen, G. (2019). Contemporary strategies for enhancing nitrogen retention and mitigating nitrous oxide emission in agricultural soils: Present and future. Environment, Development and Sustainability, 1-39.
Li, S., & Chen, G. (2020a). Agricultural waste-derived superabsorbent hydrogels: Preparation, performance, and socioeconomic impacts. Journal of Cleaner Production, 251, 119669.
Li, S., & Chen, G. (2020b). Contemporary strategies for enhancing nitrogen retention and mitigating nitrous oxide emission in agricultural soils: Present and future. Environment, Development and Sustainability, 22(4), 2703-2741.
Li, S., Harris, S., Anandhi, A., & Chen, G. (2019). Predicting biochar properties and functions based on feedstock and pyrolysis temperature: A review and data syntheses. Journal of Cleaner Production, 215, 890-902.
Li, X., He, J.-Z., Liu, Y.-R., & Zheng, Y.-M. (2013). Effects of super absorbent polymers on soil microbial properties and Chinese cabbage (Brassica chinensis) growth. Journal of Soils and Sediments, 13(4), 711-719.
Li, X., Li, Q., Xu, X., Su, Y., Yue, Q., & Gao, B. (2016). Characterization, swelling and slow-release properties of a new controlled release fertilizer based on wheat straw cellulose hydrogel. Journal of the Taiwan Institute of Chemical Engineers, 60, 564-572.
Li, Y., Li, J., Gao, L., & Tian, Y. (2018). Irrigation has more influence than fertilization on leaching water quality and the environmental risk in excessively fertilized vegetable soils. PLoS ONE, 13(9), e0204570.
Li, Z., He, G., Hua, J., Wu, M., Guo, W., Gong, J., Zhang, J., & Qiao, C. (2017). Preparation of γ-PGA hydrogels and swelling behaviors in salt solutions with different ionic valence numbers. Rsc Advances, 7(18), 11085-11093.
Lin, X., Guo, L., Shaghaleh, H., Hamoud, Y. A., Xu, X., & Liu, H. (2021). A TEMPO-oxidized cellulose nanofibers/MOFs hydrogel with temperature and pH responsiveness for fertilizers slow-release. International Journal of Biological Macromolecules, 191, 483-491.
Liu, J., Hull, V., Godfray, H., Tilman, D., Gleick, P., Hoff, H., Pahl-Wostl, C., Xu, Z., Chung, M., Sun, J., & Li, S. (2018a). Nexus approaches to global sustainable development. Nature Sustainability, 1, 466-476.
Liu, J., Hull, V., Godfray, H. C. J., Tilman, D., Gleick, P., Hoff, H., Pahl-Wostl, C., Xu, Z., Chung, M. G., Sun, J., & Li, S. (2018b). Nexus approaches to global sustainable development. Nature Sustainability, 1(9), 466-476.
Liu, J., Li, Q., Su, Y., Yue, Q., & Gao, B. (2014). Characterization and swelling-deswelling properties of wheat straw cellulose based semi-IPNs hydrogel. Carbohydrate Polymers, 107, 232-240.
Liu, M., Liang, R., Zhan, F., Liu, Z., & Niu, A. (2006). Synthesis of a slow-release and superabsorbent nitrogen fertilizer and its properties. Polymers for Advanced Technologies, 17(6), 430-438.
Lu, S., Feng, C., Gao, C., Wang, X., Xu, X., Bai, X., Gao, N., & Liu, M. (2016). Multifunctional environmental smart fertilizer based on 1-aspartic acid for sustained nutrient release. Journal of Agricultural and Food Chemistry, 64(24), 4965-4974.
Luckachan, G. E., & Pillai, C. (2011). Biodegradable polymers: A review on recent trends and emerging perspectives. Journal of Polymers and the Environment, 19(3), 637-676.
Machado, A., Kloas, W., Zarfl, C., Hempel, S., & Rillig, M. (2018). Microplastics as an emerging threat to terrestrial ecosystems. Global Change Biology, 24, 1405-1416.
Marandi, G. B., Mahdavinia, G. R., & Ghafary, S. (2011). Collagen-g-poly(sodium acrylate-co-acrylamide)/sodium montmorillonite superabsorbent nanocomposites: Synthesis and swelling behavior. Journal of Polymer Research, 18(6), 1487-1499.
Mishra, S., Thombare, N., Ali, M., & Swami, S. (2018). Polymer gels, pp. 185-228.
Moal, M. L., Gascuel-Odoux, C., Menesguen, A., Souchon, Y., Etrillard, C., Levain, A., Moatar, F., Pannard, A., Souchu, P., Lefebvre, A., & Pinay, G. (2019). Eutrophication: A new wine in an old bottle? Science of the Total Environment, 651, 1-11.
Montesano, F. F., Parente, A., Santamaria, P., Sannino, A., & Serio, F. (2015). Biodegradable superabsorbent hydrogel increases water retention properties of growing media and plant growth. Agriculture and Agricultural Science Procedia, 4, 451-458.
Murthy, P. S. K., Mohan, Y. M., Sreeramulu, J., & Raju, K. M. (2006). Semi-IPNs of starch and poly(acrylamide-co-sodium methacrylate): Preparation, swelling and diffusion characteristics evaluation. Reactive and Functional Polymers, 66(12), 1482-1493.
Narjary, B., Aggarwal, P., Kumar, S., & Meena, M. (2013). Significance of hydrogel and its application in agriculture. In ICAR.
Nascimento, C. D. V., Simmons, R. W., & Feitosa, J.P.d.A., Dias, C.T.d.S. and Costa, M.C.G. (2021). Potential of superabsorbent hydrogels to improve agriculture under abiotic stresses. Journal of Arid Environments, 189, 104496.
Ni, B., Liu, M., Lii, S., Xie, L., & Wang, Y. (2011). Environmentally friendly slow-release nitrogen fertilizer. Journal of Agricultural and Food Chemistry, 59(18), 10169-10175.
Ni, N., & Dumont, M. J. (2016). Protein-based hydrogels derived from industrial byproducts containing collagen, Keratin. Zein and Soy. Waste Biomass Valorization, 8(2), 285-300.
Nnadi, F., & Brave, C. (2011). Environmentally friendly superabsorbent polymers for water conservation in agricultural lands. Journal of Soil Science and Environmental Management, 2(7), 206-211.
Noppakundilograt, S., Pheatcharat, N., & Kiatkamjornwong, S. (2015). Multilayer-coated NPK compound fertilizer hydrogel with controlled nutrient release and water absorbency. Journal of Applied Polymer Science, 132, 2.
Nyyssölä, A., & Ahlgren, J. (2019). Microbial degradation of polyacrylamide and the deamination product polyacrylate. International Biodeterioration & Biodegradation, 139, 24-33.
Olad, A., Zebhi, H., Salari, D., Mirmohseni, A., & Tabar, A. R. (2018b). Water retention and slow release studies of a salep-based hydrogel nanocomposite reinforced with montmorillonite clay. New Journal of Chemistry, 42(4), 2758-2766.
Pakdel, P., & Peighambardoust, S. (2018). A review on acrylic based hydrogels and their applications in wastewater treatment. Journal of Environmental Management, 217, 123-143.
Pang, S., Chin, S., Tay, S., & Tchong, F. (2011). Starch-maleate-polyvinyl alcohol hydrogels with controllable swelling behaviors. Carbohydrate Polymers, 84(1), 424-429.
Puoci, F., lemma, F., Spizzirri, U. G., Cirillo, G., Curcio, M., & Picci, N. (2008). Polymer in agriculture: A review. American Journal of Agricultural and Biological Sciences, 3, 299-314.
Qi, H., Ma, R., Shi, C., Huang, Z., Liu, S., Sun, L., & Hu, T. (2019). Novel low-cost carboxymethyl cellulose microspheres with excellent fertilizer absorbency and release behavior for saline-alkali soil. International Journal of Biological Macromolecules, 131, 412-419.
Qi, X., Wu, L., Su, T., Zhang, J., & Dong, W. (2018). Polysaccharide-based cationic hydrogels for dye adsorption. Colloids and Surfaces B: Biointerfaces, 170, 364-372.
Qiu, X., & Hu, S. (2013). “Smart” materials based on cellulose: A review of the preparations, properties, and applications. Materials (basel), 6(3), 738-781.
Quesada-Perez, M., Maroto-Centeno, J. A., Forcada, J., & Hidalgo-Alvarez, R. (2011). Gel swelling theories: The classical formalism and recent approaches. Soft Matter, 7(22), 10536-10547.
Raafat, A. I., Eid, M., & El-Arnaouty, M. B. (2012). Radiation synthesis of superabsorbent CMC based hydrogels for agriculture applications. Nuclear Instruments and Methods in Physics Research Section B: Beam Interactions with Materials and Atoms, 283, 71-76.
Raju, K. M., & Raju, M. P. (2001a). Synthesis and swelling properties of superabsorbent copolymers.
Advances in Polymer Technology, 20(2), 146-154.
Raju, K. M., Raju, M. P., & Mohan, Y. M. (2002). Synthesis and water absorbency of crosslinked superabsorbent polymers. Journal of Applied Polymer Science, 85(8), 1795-1801.
Raju, M. P., & Raju, K. M. (2001b). Design and synthesis of superabsorbent polymers. Journal of Applied Polymer Science, 80(14), 2635-2639.
Ramli, R. A. (2019). Slow release fertilizer hydrogels: A review. Polymer Chemistry, 10(45), 6073-6090. Ravishankar, K., & Dhamodharan, R. (2020). Advances in chitosan-based hydrogels: Evolution from covalently crosslinked systems to ionotropically crosslinked superabsorbents. Reactive and Functional Polymers, 149, 104517.
Riad, G. S., Youssef, S. M., El-Azm, N. A. I. A., & Ahmed, E. M. (2017). Amending sandy soil with biochar or/and superabsorbent polymer mitigates the adverse effects of drought stress on green pea. Egyptian Journal of Horticulture, 45, 169-183.
Rizwan, M., Rubina Gilani, S., Iqbal Durani, A., & Naseem, S. (2021). Materials diversity of hydrogel: Synthesis, polymerization process and soil conditioning properties in agricultural field. Journal of Advanced Research, 33, 15-40.
Rop, K., Mbui, D., Njomo, N., Karuku, G. N., Michira, I., & Ajayi, R. F. (2019). Biodegradable water hyacinth cellulose-graft-poly(ammonium acrylate-co-acrylic acid) polymer hydrogel for potential agricultural application. Heliyon, 5(3), e01416.
Saalwächter, K., Chassé, W., & Sommer, J. U. (2013). Structure and swelling of polymer networks: Insights from NMR. Soft Matter, 9(29), 6587-6593.
Sabadini, R. C., Fernandes, M., de Zea Bermudez, V., Pawlicka, A., & Silva, M. M. (2022). Eco-friendly superabsorbent hydrogels based on starch, gellan gum, citric acid, and nanoclays for soil humidity control. Journal of Applied Polymer Science, 139(41), e52998.
Saeidipour, F., Mansourpour, Z., Mortazavian, E., Rafiee-Tehrani, N., & Rafiee-Tehrani, M. (2017). New comprehensive mathematical model for HPMC-MCC based matrices to design oral controlled release systems. European Journal of Pharmaceutics and Biopharmaceutics, 121, 61-72.
Saha, A., Sekharan, S., & Manna, U. (2020). Superabsorbent hydrogel (SAH) as a soil amendment for drought management: A review. Soil and Tillage Research, 204, 104736.
Salim, N., & Raza, A. (2020). Nutrient use efficiency (NUE) for sustainable wheat production: A review.
Journal of Plant Nutrition, 43(2), 297-315.
Sarkar, D. J., Bera, T., Singh, A. (2019). Release of urea from cellulosic hydrogel coated urea granule: Modeling effect of crosslink density and pH triggering. Polymer-Plastics Technology and Materials, 1-13. Sarkar, D. J., Singh, A., Mandal, P., Kumar, A., & Parmar, B. S. (2014). Synthesis and characterization of poly (CMC-g-cl-PAam/Zeolite) superabsorbent composites for controlled delivery of zinc micronutrient: Swelling and release behavior. Polymer-Plastics Technology and Engineering, 54(4), 357-367.
Sarkar, K., & Sen, K. (2018). Polyvinyl alcohol based hydrogels for urea release and Fe(III) uptake from soil medium. Journal of Environmental Chemical Engineering, 6(1), 736-744.
Saruchi, K. V., Mittal, H., & Alhassan, S. M. (2019). Biodegradable hydrogels of tragacanth gum polysaccharide to improve water retention capacity of soil and environment-friendly controlled release of agrochemicals. International Journal of Biological Macromolecules, 132, 1252-1261.
Schott, H. (1992). Swelling kinetics of polymers. Journal of Macromolecular Science, Part B, B31(1), 1-9.
Siegel, R. A., & Rathbone, M. J. (2012). Fundamentals and applications of controlled release drug delivery (pp. 19-43). Boston: Springer.
Siepmann, J., & Peppas, N. A. (2012). Modeling of drug release from delivery systems based on hydroxypropyl methylcellulose (HPMC). Advanced Drug Delivery Reviews, 64, 163-174.
Singh, A., Sarkar, D. J., Mittal, S., Dhaka, R., Maiti, P., Singh, A., Raghav, T., Solanki, D., Ahmed, N., & Singh, S. B. (2019). Zeolite reinforced carboxymethyl cellulose-Na⁺-g-cl-poly(AAm) hydrogel composites with pH responsive phosphate release behavior. Journal of Applied Polymer Science, 136(15), 47332.
Singh, A., Sarkar, D. J., Singh, A. K., Parsad, R., Kumar, A., & Parmar, B. S. (2011). Studies on novel nanosuperabsorbent composites: Swelling behavior in different environments and effect on water absorption and retention properties of sandy loam soil and soil-less medium. Journal of Applied Polymer Science, 120(3), 1448-1458.
Singh, B., Chauhan, G. S., Sharma, D. K., Kant, A., Gupta, I., & Chauhan, N. (2006).
The release dynamics of model drugs from the psyllium and N-hydroxymethylacrylamide based hydrogels. International Journal of Pharmaceutics, 325, 15-25.
Singh, S., Shukla, A., Chaudhary, S., Bhushan, C., Negi, M., & Mahapatra, B. (2018). Influence of irrigation scheduling and hydrogel application on growth and yield of Indian mustard (Brassica juncea). Indian Journal of Agronomy, 63(2), 246-249.
Singh, T., & Singhal, R. (2018) Water quality management. In Singh, V., Yadav, S., & Yadava, R. (Eds.), (pp. 257-267). Springer.
Suresh, R., Prasher, S. O., Patel, R. M., Qi, Z., Elsayed, E., Schwinghamer, T., & Ehsan, A. M. (2018). Super absorbent polymer and irrigation regime effects on growth and water use efficiency of container-grown cherry tomatoes. Transactions of the ASABE, 61(2), 523-531.
Talaat, H. A., Sorour, M. H., Aboulnour, A. G., Shaalan, H. F., Ahmed, E. M., Awad, A. M., & Ahmed, M. A. (2008). Development of a multi-component fertilizing hydrogel with relevant techno-economic indicators. American-Eurasian Journal of Agricultural and Environmental Sciences, 3(5), 764-770.
Tanan, W., Panichpakdee, J., & Saengsuwan, S. (2019). Novel biodegradable hydrogel based on natural polymers: Synthesis, characterization, swelling/reswelling and biodegradability. European Polymer Journal, 112, 678-687.
Tanan, W., Panichpakdee, J., Suwanakood, P., & Saengsuwan, S. (2021). Biodegradable hydrogels of cassava starch-g-polyacrylic acid/natural rubber/polyvinyl alcohol as environmentally friendly and highly efficient coating material for slow-release urea fertilizers. Journal of Industrial and Engineering Chemistry, 101, 237-252.
Thakur, S., Govender, P., Mamo, M., Tamulevicius, S., & Thakur, V. (2017). Recent progress in gelatin hydrogel nanocomposites for water purification and beyond. Vacuum, 146, 396-408.
Thombare, N., Mishra, S., Siddiqui, M. Z., Jha, U., Singh, D., & Mahajan, G. R. (2018). Design and development of guar gum based novel, superabsorbent and moisture retaining hydrogels for agricultural applications. Carbohydrate Polymers, 185, 169-178.
Tian, H., Tang, Z., Zhuang, X., Chen, X., & Jing, X. (2012). Biodegradable synthetic polymers: Preparation, functionalization and biomedical application. Progress in Polymer Science, 37(2), 237-280.
Tuncaboylu, D. C., Sari, M., Oppermann, W., & Okay, O. (2011). Tough and self-healing hydrogels formed via hydrophobic interactions. Macromolecules, 44(12), 4997-5005.
Ullah, F., Othman, M., Bisyrul, H., Javed, F., Ahmad, Z., & Akil, H. M. (2015). Classification, processing and application of hydrogels: A review. Materials Science and Engineering: C, 57, 414-433.
Urbano-Juan, M. M., Socías-Viciana, M. M., & Ureña-Amate, M. D. (2019). Evaluation of nitrate controlled release systems based on (acrylamide-co-itaconic acid) hydrogels. Reactive and Functional Polymers, 141, 82-90.
Wang, X., Hou, H., Li, Y., Wang, Y., Hao, C., & Ge, C. (2016). A novel semi-IPN hydrogel: Preparation, swelling properties and adsorption studies of Co (II). Journal of Industrial and Engineering Chemistry, 41, 82-90.
Wang, Y., Liu, M., Ni, B., & Xie, L. (2012). κ-Carrageenan-sodium alginate beads and superabsorbent coated nitrogen fertilizer with slow-release, water-retention, and anticompaction properties. Industrial & Engineering Chemistry Research, 51(3), 1413-1422.
Wang, Y., Zhu, Y., Zhang, S., & Wang, Y. (2018). What could promote farmers to replace chemical fertilizers with organic fertilizers? Journal of Cleaner Production, 199, 882-890.
Watcharamul, S., Lerddamrongchai, S., Siripongpreda, T., Rodtassana, C., Nuisin, R., & Kiatkamjornwong,
S. (2022). Effects of carboxymethyl cellulose/nano-calcium carbonate hydrogel amendment of loamy sand soil for maize growth. ACS Agricultural Science and Technology, 2(5), 1071-1080.
Wu, Y., Brickler, C., Li, S., & Chen, G. (2021a). Synthesis of microwave-mediated biochar-hydrogel composites for enhanced water absorbency and nitrogen release. Polymer Testing, 93, 106996.
Wu, Y., Li, S., & Chen, G. (2020). Impact of humic acids on phosphorus retention and transport. Journal of Soil Science and Plant Nutrition, 20(4), 2431-2439.
Wu, Y., Li, S., & Chen, G. (2021b). Impacts of mechanical and chemical factors on the water-holding capacity of polyacrylamide in sand: Models and mechanisms. Soil Research, 59(5), 501-510.
Xiao, X. M., Yu, L., Xie, F. W., Bao, X. Y., Liu, H. S., Ji, Z. L., & Chen, L. (2017). One-step method to prepare starch-based superabsorbent polymer for slow release of fertilizer. Chemical Engineering Journal, 309, 607-616.
Xiong, B., Loss, R. D., Shields, D., Pawlik, T., Hochreiter, R., Zydney, A. L., & Kumar, M. (2018). Polyacrylamide degradation and its implications in environmental systems. NPJ Clean Water, 1(1), 17.
Yang, J., Yan, Q., Liu, H., & Hu, Y. (2006). A molecular thermodynamic model for binary lattice polymer solutions. Polymer, 47(14), 5187-5195.
Yazdani, F., Allahdadi, I., & Akbari, G. A. (2007). Impact of superabsorbent polymer on yield and growth analysis of soybean (Glycine max L.) under drought stress condition. Pakistan Journal of Biological Sciences, 10, 4190-4196.
Yi, X., He, J., Guo, Y., Han, Z., Yang, M., Jin, J., Gu, J., Ou, M., & Xu, X. (2018). Encapsulating Fe₃O₄ into calcium alginate coated chitosan hydrochloride hydrogel beads for removal of Cu (II) and U (VI) from aqueous solutions. Ecotoxicology and Environmental Safety, 147, 699-707.
Yiamsawas, D., Kangwansupamonkon, W., Chailapakul, O., & Kiatkamjornwong, S. (2007). Synthesis and swelling properties of poly[acrylamide-co-(crotonic acid)] superabsorbents. Reactive and Functional Polymers, 67(10), 865-882.
Yu, F., Fu, R., Xie, Y., & Chen, W. (2015). Isolation and characterization of polyacrylamide-degrading bacteria from dewatered sludge. International Journal of Environmental Research and Public Health, 12(4), 4214-4230.
Yuan, H., Li, S., Liu, J., Song, C., & Chen, G. (2017). Cry1Ab adsorption and transport in humic acidcoated geological formation of alumino-silica clays. Water, Air, and Soil Pollution, 228, 387.
Zhang, J., Li, A., & Wang, A. (2006). Study on superabsorbent composite. VI. Preparation, characterization and swelling behaviors of starch phosphate-graft-acrylamide/attapulgite superabsorbent composite. Carbohydrate Polymers, 65(2), 150-158.
Zhao, C., Zhang, L., Zhang, Q., Wang, J., Wang, S., Zhang, M., & Liu, Z. (2022). The effects of bio-based superabsorbent polymers on the water/nutrient retention characteristics and agricultural productivity of a saline soil from the Yellow River Basin, China. Agricultural Water Management, 261, 107388.
Zhao, C., Zhang, M., Liu, Z., Guo, Y., & Zhang, Q. (2019). Salt-tolerant superabsorbent polymer with high capacity of water-nutrient retention derived from sulfamic acid-modified starch. ACS Omega, 4(3), 5923-5930.
Zhong, K., Lin, Z. T., Zheng, X. L., Jiang, G. B., Fang, Y. S., Mao, X. Y., & Liao, Z. W. (2013). Starch derivative-based superabsorbent with integration of water-retaining and controlled-release fertilizers. Carbohydrate Polymers, 92(2), 1367-1376.
Zhu, W., Zhang, Y., Wang, P., Yang, Z., Yasin, A., & Zhang, L. (2019). Preparation and applications of saltresistant superabsorbent poly (acrylic acid-acrylamide/fly ash) composite. Materials (basel), 12(4), 569.
Zohourian, M. M., & Kabiri, K. (2008). Superabsorbent polymer materials: a review. Iranian Polymer Journal, 17(6), 451-477.

What is claimed is:

1. A composition comprising a hydrochar, wherein the hydrochar comprises microwave-irradiated biomass.

2. The composition of claim 1, further comprising hydroxymethylfurfural (HMF).

3. The composition of claim 2, wherein HMF is deposited on the hydrochar.

4. The composition of claim 1, wherein the composition further comprises an initiator.

5. The composition of claim 4, wherein the initiator comprises potassium persulfate, ammonium persulfate, or any combination thereof.

6. The composition of claim 1, wherein the composition further comprises a crosslinker.

7. The composition of claim 6, wherein the crosslinker comprises N,N-bisacrylamide methylene.

8. The composition of claim 1, wherein the composition further comprises a solvent.

9. The composition of claim 8, wherein the solvent comprises NaOH, urea, distilled H₂O, or any combination thereof.

10. The composition of claim 1, wherein the composition further comprises biochar.

11. The composition of claim 10, wherein the biochar is copolymerized with the hydrochar.

12. The composition of claim 1, wherein the biomass comprises switchgrass, water oak, leaves, biosolid, food waste, or any combination thereof.

13. The composition of claim 1, wherein the biomass is microwave-irradiated via microwave mediated hydrothermal carbonization.

14. A method of making the composition of claim 1, the method comprising:
irradiating the biomass with microwaves under an inert atmosphere at conditions effective to yield the hydrochar.

15. The method of claim 14, further comprising recirculation of a liquid during the irradiation step.

16. The method of claim 14, wherein the conditions effective comprise irradiating with microwaves having a frequency, an energy, or a combination thereof, sufficient to heat the biomass to a temperature sufficient to yield the hydrochar.

17. The method of claim 14, wherein the method is performed at a temperature of from 150° C. to 250° C. at a pressure of 6 MPa.

18. The method of claim 14, wherein the irradiation step lasts from 5 minutes to 2 hours.

19. The method of claim 14, wherein generating the composition has an activation energy of from 150 MJ/kg to 255 MJ/kg.

20. A method of improving the quality of a soil comprising combining the soil with the composition of claim 1.
